(19) United States
(12) Patent Application Publication
(10) Pub. No.: US 2013/0127922 A1
(43) Pub. Date: May 23, 2013

(54) STRUCTURES FOR DIRECTING INCIDENT LIGHT ONTO THE ACTIVE AREAS OF DISPLAY ELEMENTS

(71) Applicants: Evgeni Poliakov, San Mateo, CA (US); Ion Bita, San Jose, CA (US); Kollengode S. Narayanan, Cupertino, CA (US)

(72) Inventors: Evgeni Poliakov, San Mateo, CA (US); Ion Bita, San Jose, CA (US); Kollengode S. Narayanan, Cupertino, CA (US)

(73) Assignee: QUALCOMM MEMS Technologies, Inc, San Diego, CA (US)

(21) Appl. No.: 13/300,522

(22) Filed: Nov. 18, 2011

(51) Int. Cl. G02B 26/00; B05D 5/06; G09G 5/10

(52) U.S. Cl. 345/690; 359/292; 427/162

(57) ABSTRACT

This disclosure provides systems, methods and apparatus for improving brightness, contrast, and viewable angle of a reflective display. In one aspect, a display includes a structure having a steering layer including steering features. The steering features are configured to direct light away from inactive regions of a display and towards active regions of the display. The structure may also include a diffuser for scattering light incident on the display and reflected by the display.

### TECHNICAL FIELD

This disclosure is related to features integrated with microelectromechanical systems (MEMS) display devices.

### DESCRIPTION OF THE RELATED TECHNOLOGY

Electromechanical systems include devices having electrical and mechanical elements, actuators, transducers, sensors, optical components (e.g., mirrors) and electronics. Electromechanical systems can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of electromechanical systems device is called an interferometric modulator (IMOD). As used herein, the term interferometric modulator or interferometric light modulator refers to a device that selectively absorbs and/or reflects light using the principles of optical interference. In some implementations, an interferometric modulator may include a pair of conductive plates, one or both of which may be transparent and/or reflective, wholly or in part, and capable of relative motion upon application of an appropriate electrical signal. In an implementation, one plate may include a stationary layer deposited on a substrate and the other plate may include a reflective membrane separated from the stationary layer by an air gap. The position of one plate in relation to another can change the optical interference of light incident on the interferometric modulator. Interferometric modulator devices have a wide range of applications, and are anticipated to be used in improving existing products and creating new products, especially those with display capabilities.

A reflective display may include active areas capable of reflecting light for displaying an image and inactive areas interposed between the active areas. Since a reflective display generates an image based on incident light that is incident on both active regions and inactive regions of the display, light reflections from inactive areas that are adjacent to the active areas may lead to a reduction in contrast and lower device efficiency in displaying an image to a viewer.

### SUMMARY

The systems, methods and devices of the disclosure each have several innovative aspects, no single one of which is solely responsible for the desirable attributes disclosed herein.

One innovative aspect of the subject matter described in this disclosure can be implemented in a display device including a light-modulating array including a plurality of light-modulating elements. The plurality of light-modulating elements include movable reflective surfaces and static reflective surfaces defining active regions of the light-modulating array spaced apart by inactive regions of the light-modulating array. The display device also includes a steering layer including steering features configured to direct light away from the inactive regions and towards the active regions, a substrate between the light-modulating array and the steering layer, and a diffuser.

Another innovative aspect of the subject matter described in this disclosure can be implemented in a method of manufacturing a display device. The method includes forming a steering layer over a first side of a substrate. The steering layer includes steering features configured to direct light towards active regions of a light-modulating array formed over a second side of the substrate opposite the first side and away from inactive regions of the light-modulating array. The light-modulating array includes a plurality of light-modulating elements including movable reflective surfaces and static reflective surfaces defining the active regions of the light-modulating array spaced apart by the inactive regions of the light-modulating array. The device includes a diffuser.

Another innovative aspect of the subject matter described in this disclosure can be implemented in a display device including a light-modulating array including a plurality of light-modulating elements. The plurality of light-modulating elements include movable reflective surfaces and static reflective surfaces defining active regions of the light-modulating array spaced apart by inactive regions of the light-modulating array. The display device also includes means for directing light away from the inactive regions and towards the active regions, a substrate between the light-modulating array and the means for directing light, and means for scattering light.

Another innovative aspect of the subject matter described in this disclosure can be implemented in a display device including a display including active regions and inactive regions between the active regions, a steering layer including steering features configured to direct light away from the inactive regions and towards the active regions, the steering features including, first portions covering the inactive regions, second portions partially covering the active regions, and a substrate between the display and the steering layer.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of an isometric view depicting two adjacent pixels in a series of pixels of an interferometric modulator (IMOD) display device.

FIG. 2 shows an example of a system block diagram illustrating an electronic device incorporating a 3×3 interferometric modulator display.

FIG. 3 shows an example of a diagram illustrating movable reflective layer position versus applied voltage for the interferometric modulator of FIG. 1.

FIG. 4 shows an example of a table illustrating various states of an interferometric modulator when various common and segment voltages are applied.

FIG. 5A shows an example of a diagram illustrating a frame of display data in the 3×3 interferometric modulator display of FIG. 2.

FIG. 5B shows an example of a timing diagram for common and segment signals that may be used to write the frame of display data illustrated in FIG. 5A.

FIG. 6A shows an example of a partial cross-section of the interferometric modulator display of FIG. 1.

FIGS. 6B-6E show examples of cross-sections of varying implementations of interferometric modulators.

FIG. 7 shows an example of a flow diagram illustrating a manufacturing process for an interferometric modulator.

FIGS. 8A-8E show examples of cross-sectional schematic illustrations of various stages in a method of making an interferometric modulator.

FIG. 9 shows an isometric view depicting an example of a display including a first display element and a second display element in a series of display elements of the display including active regions and inactive regions.

FIGS. 10A and 10B each illustrate a cross-section of an example of an optical structure including a plurality of layers.

FIGS. 11A-11D illustrate a method of manufacturing steering features of a steering layer according to some implementations.

FIG. 12A illustrates a cross-sectional view of an example of a steering layer including steering features configured as one-dimensional prisms.

FIG. 12B illustrates a top view of an example of a steering layer including steering features configured as a two-dimensional prismatic array in a steering layer.

FIGS. 13A-13I illustrate cross-sectional views of various configurations for steering features according to some implementations.

FIG. 14 illustrates a steering layer including steering features and a slanted edge surface according to some implementations.

FIG. 15 illustrates a volume diffuser integrated in a manufactured substrate/volumetric diffuser according to some implementations.

FIGS. 16A-16D illustrate an example of a method of making a manufactured substrate/volumetric and topographical diffuser and the combination of the above substrate and the above diffusers according to some implementations.

FIG. 17 illustrates a diffuser between a display and a substrate according to some implementations.

FIG. 18 illustrates an optical structure including a substrate including a volume diffuser and a separate diffuser according to some implementations.

FIGS. 19A-19D illustrate example variations of a display including combinations of steering features, volume diffusers, and topographical diffuser.

FIGS. 20A and 20B show examples of system block diagrams illustrating a display device that includes a plurality of interferometric modulators.

Like reference numbers and designations in the various drawings indicate like elements.

### DETAILED DESCRIPTION

The following detailed description is directed to certain implementations for the purposes of describing the innovative aspects. However, the teachings herein can be applied in a multitude of different ways. The described implementations may be implemented in any device that is configured to display an image, whether in motion (e.g., video) or stationary (e.g., still image), and whether textual, graphical or pictorial. More particularly, it is contemplated that the implementations may be implemented in or associated with a variety of electronic devices such as, but not limited to, mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, GPS receivers/navigators, cameras, MP3 players, camcorders, game consoles, wrist watches, clocks, calculators, television monitors, flat panel displays, electronic reading devices (e.g., e-readers), computer monitors, auto displays (e.g., odometer display, etc.), cockpit controls and/or displays, camera view displays (e.g., display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (e.g., MEMS and non-MEMS), aesthetic structures (e.g., display of images on a piece of jewelry) and a variety of electromechanical systems devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes, and electronic test equipment. Thus, the teachings are not intended to be limited to the implementations depicted solely in the Figures, but instead have wide applicability as will be readily apparent to a person having ordinary skill in the art.

Reflective displays generally rely on ambient light and/or artificial front light incident on each reflective display element. The brightness and contrast of an image displayed by a reflective display can be sensitive to the amount of incident light. Aspects of this description provide implementations that may increase the amount of light reflected by a reflective display to generate an image. According to some implementations, an optical structure includes steering features that are configured to direct light away from inactive regions of display elements of the reflective display and towards active regions of the display elements of the reflective display, and a diffuser configured to scatter incident and/or reflected light. A wide variety of shapes and sizes of steering features are possible.

The diffuser may be configured as a volume diffuser and/or as a topographical pattern diffuser that is included as part of a substrate, a diffuser layer between a substrate and the reflective display, and/or as part of the steering features. A volume diffuser may include particles and a binding material. A topographical pattern diffuser may be patterned on a surface of one or more of the substrate, a diffuser layer, and the steering features. The diffuser may be configured to scatter incident light and/or light that is reflected by the display. By scattering the reflected light, portions of the reflected light may pass through a surface including the steering features or through a flat surface.

Some implementations of the subject matter described in this disclosure may realize one or more of the following potential advantages. By directing light towards active regions of the display and away from inactive regions for the display, an image displayed by the reflective display may have enhanced contrast ratio and/or brightness. By scattering incident light and light that is reflected by the display, intensity peaks of reflected light are exhibited at different viewing angles, thereby expanding the angle at which the display may be viewed by a user. In some implementations, a viewer may view a secondary peak (low-intensity peak) compared to a primary peak (higher-intensity peak corresponding to the main viewing lobe), which may broaden the viewing angle of the display. In some implementations, the steering features, which direct light from inactive regions to the active regions, boost the device reflectivity through forwarding some portion of ambient illuminated light, which would not have been utilized by the display, towards the active regions, thereby increasing the illuminance of the display in darker environments.

An example of a suitable MEMS device, to which the described implementations may apply, is a reflective display device. Reflective display devices can incorporate interferometric modulators (IMODs) to selectively absorb and/or reflect light incident thereon using principles of optical interference. IMODs can include an absorber, a reflector that is movable with respect to the absorber, and an optical resonant cavity defined between the absorber and the reflector. The reflector can be moved to two or more different positions, which can change the size of the optical resonant cavity and thereby affect the reflectance of the interferometric modulator. The reflectance spectrums of IMODs can create fairly broad spectral bands which can be shifted across the visible wavelengths to generate different colors. The position of the spectral band can be adjusted by changing the thickness of the optical resonant cavity, e.g., by changing the position of the reflector.

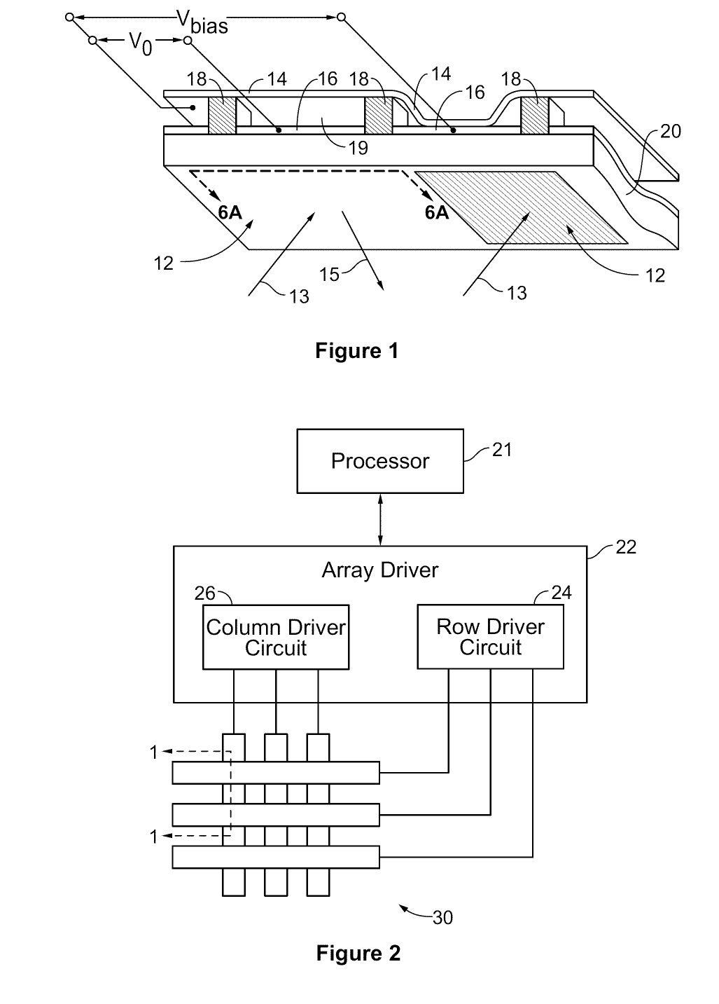

FIG. 1 shows an example of an isometric view depicting two adjacent pixels in a series of pixels of an interferometric modulator (IMOD) display device. The IMOD display device includes one or more interferometric MEMS display elements. In these devices, the pixels of the MEMS display elements can be in either a bright or dark state. In the bright (“relaxed,” “open” or “on”) state, the display element reflects a large portion of incident visible light, e.g., to a user. Conversely, in the dark (“actuated,” “closed” or “off”) state, the display element reflects little incident visible light. In some implementations, the light reflectance properties of the on and off states may be reversed. MEMS pixels can be configured to reflect predominantly at particular wavelengths allowing for a color display in addition to black and white.

The IMOD display device can include a row/column array of IMODs. Each IMOD can include a pair of reflective layers, e.g., a movable reflective layer and a fixed partially reflective layer, positioned at a variable and controllable distance from each other to form an air gap (also referred to as an optical gap or cavity). The movable reflective layer may be moved between at least two positions. In a first position, e.g., a relaxed position, the movable reflective layer can be positioned at a relatively large distance from the fixed partially reflective layer. In a second position, e.g., an actuated position, the movable reflective layer can be positioned more closely to the partially reflective layer. Incident light that reflects from the two layers can interfere constructively or destructively depending on the position of the movable reflective layer, producing either an overall reflective or non-reflective state for each pixel. In some implementations, the IMOD may be in a reflective state when unactuated, reflecting light within the visible spectrum, and may be in a dark state when actuated, reflecting light outside of the visible range (e.g., infrared light). In some other implementations, however, an IMOD may be in a dark state when unactuated, and in a reflective state when actuated. In some implementations, the introduction of an applied voltage can drive the pixels to change states. In some other implementations, an applied charge can drive the pixels to change states.

The depicted portion of the pixel array in FIG. 1 includes two adjacent interferometric modulators 12. In the IMOD 12 on the left (as illustrated), a movable reflective layer 14 is illustrated in a relaxed position at a predetermined distance from an optical stack 16, which includes a partially reflective layer. The voltage V₀ applied across the IMOD 12 on the left is insufficient to cause actuation of the movable reflective layer 14. In the IMOD 12 on the right, the movable reflective layer 14 is illustrated in an actuated position near or adjacent the optical stack 16. The voltage V_{bias} applied across the IMOD 12 on the right is sufficient to maintain the movable reflective layer 14 in the actuated position.

In FIG. 1, the reflective properties of pixels 12 are generally illustrated with arrows indicating light 13 incident upon the pixels 12, and light 15 reflecting from the pixel 12 on the left. Although not illustrated in detail, it will be understood by a person having ordinary skill in the art that most of the light 13 incident upon the pixels 12 will be transmitted through the transparent substrate 20, toward the optical stack 16. A portion of the light incident upon the optical stack 16 will be transmitted through the partially reflective layer of the optical stack 16, and a portion will be reflected back through the transparent substrate 20. The portion of light 13 that is transmitted through the optical stack 16 will be reflected at the movable reflective layer 14, back toward (and through) the transparent substrate 20. Interference (constructive or destructive) between the light reflected from the partially reflective layer of the optical stack 16 and the light reflected from the movable reflective layer 14 will determine the wavelength(s) of light 15 reflected from the pixel 12.

The optical stack 16 can include a single layer or several layers. The layer(s) can include one or more of an electrode layer, a partially reflective and partially transmissive layer and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals, e.g., chromium (Cr), semiconductors, and dielectrics. The partially reflective layer can be formed of one or more layers of materials, and each of the layers can be formed of a single material or a combination of materials. In some implementations, the optical stack 16 can include a single semi-transparent thickness of metal or semiconductor which serves as both an optical absorber and conductor, while different, more conductive layers or portions (e.g., of the optical stack 16 or of other structures of the IMOD) can serve to bus signals between IMOD pixels. The optical stack 16 also can include one or more insulating or dielectric layers covering one or more conductive layers or a conductive/absorptive layer.

In some implementations, the layer(s) of the optical stack 16 can be patterned into parallel strips, and may form row electrodes in a display device as described further below. As will be understood by one having skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of posts 18 and an intervening sacrificial material deposited between the posts 18. When the sacrificial material is etched away, a defined gap 19, or optical cavity, can be formed between the movable reflective layer 14 and the optical stack 16. In some implementations, the spacing between posts 18 may be on the order of 1-1000 um, while the gap 19 may be on the order of <10,000 Angstroms (Å).

In some implementations, each pixel of the IMOD, whether in the actuated or relaxed state, is essentially a capacitor formed by the fixed and moving reflective layers. When no voltage is applied, the movable reflective layer 14 remains in a mechanically relaxed state, as illustrated by the pixel 12 on the left in FIG. 1, with the gap 19 between the movable reflective layer 14 and optical stack 16. However, when a potential difference, e.g., voltage, is applied to at least one of a selected row and column, the capacitor formed at the intersection of the row and column electrodes at the corresponding pixel becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated pixel 12 on the right in FIG. 1. The behavior is the same regardless of the polarity of the applied potential difference. Though a series of pixels in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

FIG. 2 shows an example of a system block diagram illustrating an electronic device incorporating a 3×3 interferometric modulator display. The electronic device includes a processor 21 that may be configured to execute one or more software modules. In addition to executing an operating system, the processor 21 may be configured to execute one or more software applications, including a web browser, a telephone application, an email program, or any other software application.

The processor 21 can be configured to communicate with an array driver 22. The array driver 22 can include a row driver circuit 24 and a column driver circuit 26 that provide signals to, e.g., a display array or panel 30. The cross section of the IMOD display device illustrated in FIG. 1 is shown by the lines 1-1 in FIG. 2. Although FIG. 2 illustrates a 3×3 array of IMODs for the sake of clarity, the display array 30 may contain a very large number of IMODs, and may have a different number of IMODs in rows than in columns, and vice versa.

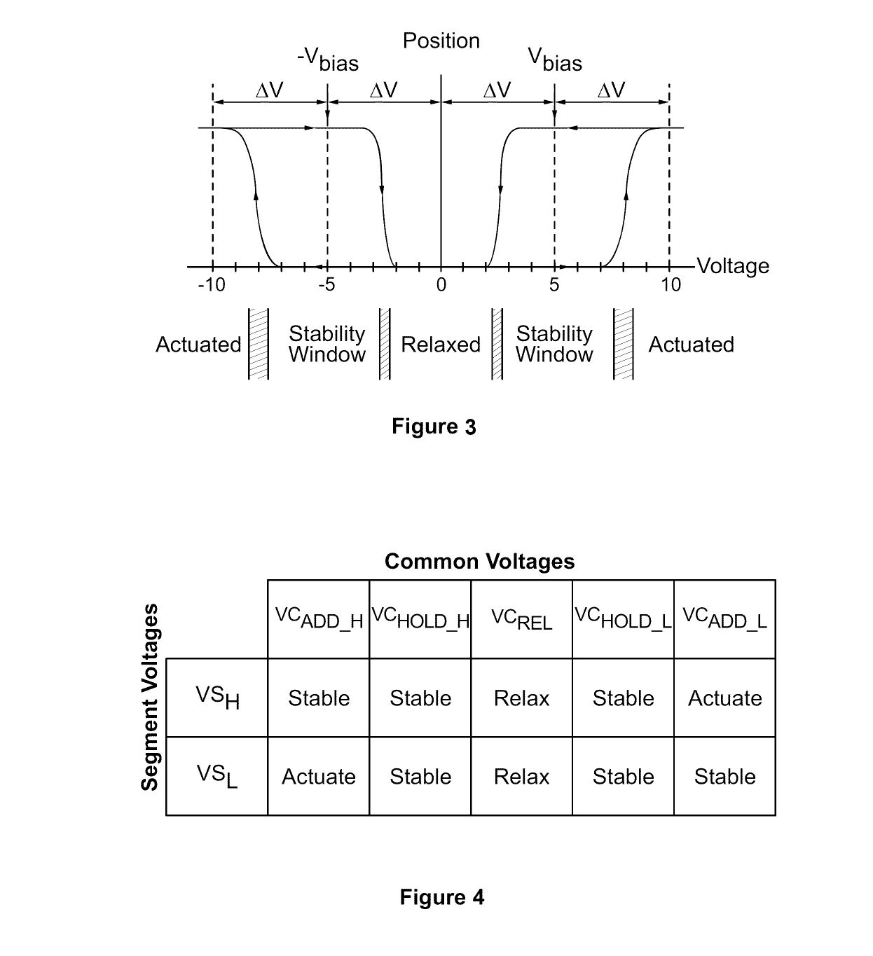

FIG. 3 shows an example of a diagram illustrating movable reflective layer position versus applied voltage for the interferometric modulator of FIG. 1. For MEMS interferometric modulators, the row/column (e.g., common/segment) write procedure may take advantage of a hysteresis property of these devices as illustrated in FIG. 3. An interferometric modulator may require, for example, about a 10-volt potential difference to cause the movable reflective layer, or mirror, to change from the relaxed state to the actuated state. When the voltage is reduced from that value, the movable reflective layer maintains its state as the voltage drops back below, e.g., 10-volts, however, the movable reflective layer does not relax completely until the voltage drops below 2-volts. Thus, a range of voltage, approximately 3 to 7-volts, as shown in FIG. 3, exists where there is a window of applied voltage within which the device is stable in either the relaxed or actuated state. This is referred to herein as the “hysteresis window” or “stability window.” For a display array 30 having the hysteresis characteristics of FIG. 3, the row/column write procedure can be designed to address one or more rows at a time, such that during the addressing of a given row, pixels in the addressed row that are to be actuated are exposed to a voltage difference of about 10-volts, and pixels that are to be relaxed are exposed to a voltage difference of near zero volts. After addressing, the pixels are exposed to a steady state or bias voltage difference of approximately 5-volts such that they remain in the previous strobing state. In this example, after being addressed, each pixel sees a potential difference within the “stability window” of about 3-7-volts. This hysteresis property feature enables the pixel design, e.g., illustrated in FIG. 1, to remain stable in either an actuated or relaxed pre-existing state under the same applied voltage conditions. Since each IMOD pixel, whether in the actuated or relaxed state, is essentially a capacitor formed by the fixed and moving reflective layers, this stable state can be held at a steady voltage within the hysteresis window without substantially consuming or losing power. Moreover, essentially little or no current flows into the IMOD pixel if the applied voltage potential remains substantially fixed.

In some implementations, a frame of an image may be created by applying data signals in the form of “segment” voltages along the set of column electrodes, in accordance with the desired change (if any) to the state of the pixels in a given row. Each row of the array can be addressed in turn, such that the frame is written one row at a time. To write the desired data to the pixels in a first row, segment voltages corresponding to the desired state of the pixels in the first row can be applied on the column electrodes, and a first row pulse in the form of a specific “common” voltage or signal can be applied to the first row electrode. The set of segment voltages can then be changed to correspond to the desired change (if any) to the state of the pixels in the second row, and a second common voltage can be applied to the second row electrode. In some implementations, the pixels in the first row are unaffected by the change in the segment voltages applied along the column electrodes, and remain in the state they were set to during the first common voltage row pulse. This process may be repeated for the entire series of rows, or alternatively, columns, in a sequential fashion to produce the image frame. The frames can be refreshed and/or updated with new image data by continually repeating this process at some desired number of frames per second.

The combination of segment and common signals applied across each pixel (that is, the potential difference across each pixel) determines the resulting state of each pixel. FIG. 4 shows an example of a table illustrating various states of an interferometric modulator when various common and segment voltages are applied. As will be readily understood by one having ordinary skill in the art, the “segment” voltages can be applied to either the column electrodes or the row electrodes, and the “common” voltages can be applied to the other of the column electrodes or the row electrodes.

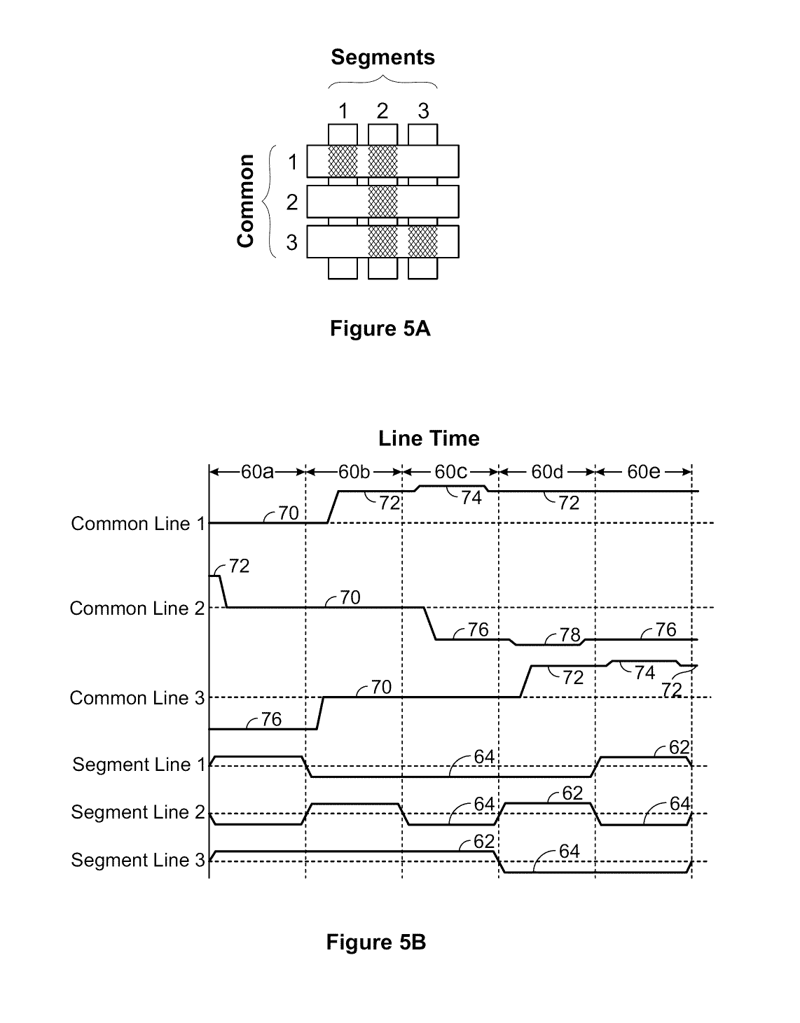

As illustrated in FIG. 4 (as well as in the timing diagram shown in FIG. 5B), when a release voltage VC_{REL} is applied along a common line, all interferometric modulator elements along the common line will be placed in a relaxed state, alternatively referred to as a released or unactuated state, regardless of the voltage applied along the segment lines, e.g., high segment voltage VS_{H} and low segment voltage VS_{L}. In particular, when the release voltage VC_{REL} is applied along a common line, the potential voltage across the modulator (alternatively referred to as a pixel voltage) is within the relaxation window (see FIG. 3, also referred to as a release window) both when the high segment voltage VS_{H} and the low segment voltage VS_{L} are applied along the corresponding segment line for that pixel.

When a hold voltage is applied on a common line, such as a high hold voltage VC_{HOLD}_{_{—}}_{H} or a low hold voltage VC_{HOLD}_{_{—}}_{L}, the state of the interferometric modulator will remain constant. For example, a relaxed IMOD will remain in a relaxed position, and an actuated IMOD will remain in an actuated position. The hold voltages can be selected such that the pixel voltage will remain within a stability window both when the high segment voltage VS_{H} and the low segment voltage VS_{L} are applied along the corresponding segment line. Thus, the segment voltage swing, e.g., the difference between the high VS_{H} and low segment voltage VS_{L}, is less than the width of either the positive or the negative stability window.

When an addressing, or actuation, voltage is applied on a common line, such as a high addressing voltage VC_{ADD}_{_{—}}_{H} or a low addressing voltage VC_{ADD}_{_{—}}_{L}, data can be selectively written to the modulators along that line by application of segment voltages along the respective segment lines. The segment voltages may be selected such that actuation is dependent upon the segment voltage applied. When an addressing voltage is applied along a common line, application of one segment voltage will result in a pixel voltage within a stability window, causing the pixel to remain unactuated. In contrast, application of the other segment voltage will result in a pixel voltage beyond the stability window, resulting in actuation of the pixel. The particular segment voltage which causes actuation can vary depending upon which addressing voltage is used. In some implementations, when the high addressing voltage VC_{ADD}_{_{—}}_{H} is applied along the common line, application of the high segment voltage VS_{H} can cause a modulator to remain in its current position, while application of the low segment voltage VS_{L} can cause actuation of the modulator. As a corollary, the effect of the segment voltages can be the opposite when a low addressing voltage VC_{ADD}_{_{—}}_{L} is applied, with high segment voltage VS_{H} causing actuation of the modulator, and low segment voltage VS_{L} having no effect (e.g., remaining stable) on the state of the modulator.

In some implementations, hold voltages, address voltages, and segment voltages may be used which always produce the same polarity potential difference across the modulators. In some other implementations, signals can be used which alternate the polarity of the potential difference of the modulators. Alternation of the polarity across the modulators (that is, alternation of the polarity of write procedures) may reduce or inhibit charge accumulation which could occur after repeated write operations of a single polarity.

FIG. 5A shows an example of a diagram illustrating a frame of display data in the 3×3 interferometric modulator display of FIG. 2. FIG. 5B shows an example of a timing diagram for common and segment signals that may be used to write the frame of display data illustrated in FIG. 5A. The signals can be applied to the, e.g., 3×3 array of FIG. 2, which will ultimately result in the line time 60e display arrangement illustrated in FIG. 5A. The actuated modulators in FIG. 5A are in a dark-state, e.g., where a substantial portion of the reflected light is outside of the visible spectrum so as to result in a dark appearance to, e.g., a viewer. Prior to writing the frame illustrated in FIG. 5A, the pixels can be in any state, but the write procedure illustrated in the timing diagram of FIG. 5B presumes that each modulator has been released and resides in an unactuated state before the first line time 60a.

During the first line time 60a: a release voltage 70 is applied on common line 1; the voltage applied on common line 2 begins at a high hold voltage 72 and moves to a release voltage 70; and a low hold voltage 76 is applied along common line 3. Thus, the modulators (common 1, segment 1), (1,2) and (1,3) along common line 1 remain in a relaxed, or unactuated, state for the duration of the first line time 60a, the modulators (2,1), (2,2) and (2,3) along common line 2 will move to a relaxed state, and the modulators (3,1), (3,2) and (3,3) along common line 3 will remain in their previous state. With reference to FIG. 4, the segment voltages applied along segment lines 1, 2 and 3 will have no effect on the state of the interferometric modulators, as none of common lines 1, 2 or 3 are being exposed to voltage levels causing actuation during line time 60a (e.g., VC_{REL}-relax and VC_{HOLD}_{_{—}}_{L}-stable).

During the second line time 60b, the voltage on common line 1 moves to a high hold voltage 72, and all modulators along common line 1 remain in a relaxed state regardless of the segment voltage applied because no addressing, or actuation, voltage was applied on the common line 1. The modulators along common line 2 remain in a relaxed state due to the application of the release voltage 70, and the modulators (3,1), (3,2) and (3,3) along common line 3 will relax when the voltage along common line 3 moves to a release voltage 70.

During the third line time 60c, common line 1 is addressed by applying a high address voltage 74 on common line 1. Because a low segment voltage 64 is applied along segment lines 1 and 2 during the application of this address voltage, the pixel voltage across modulators (1,1) and (1,2) is greater than the high end of the positive stability window (e.g., the voltage differential exceeded a predefined threshold) of the modulators, and the modulators (1,1) and (1,2) are actuated. Conversely, because a high segment voltage 62 is applied along segment line 3, the pixel voltage across modulator (1,3) is less than that of modulators (1,1) and (1,2), and remains within the positive stability window of the modulator; modulator (1,3) thus remains relaxed. Also during line time 60c, the voltage along common line 2 decreases to a low hold voltage 76, and the voltage along common line 3 remains at a release voltage 70, leaving the modulators along common lines 2 and 3 in a relaxed position.

During the fourth line time 60d, the voltage on common line 1 returns to a high hold voltage 72, leaving the modulators along common line 1 in their respective addressed states. The voltage on common line 2 is decreased to a low address voltage 78. Because a high segment voltage 62 is applied along segment line 2, the pixel voltage across modulator (2,2) is below the lower end of the negative stability window of the modulator, causing the modulator (2,2) to actuate. Conversely, because a low segment voltage 64 is applied along segment lines 1 and 3, the modulators (2,1) and (2,3) remain in a relaxed position. The voltage on common line 3 increases to a high hold voltage 72, leaving the modulators along common line 3 in a relaxed state.

Finally, during the fifth line time 60e, the voltage on common line 1 remains at high hold voltage 72, and the voltage on common line 2 remains at a low hold voltage 76, leaving the modulators along common lines 1 and 2 in their respective addressed states. The voltage on common line 3 increases to a high address voltage 74 to address the modulators along common line 3. As a low segment voltage 64 is applied on segment lines 2 and 3, the modulators (3,2) and (3,3) actuate, while the high segment voltage 62 applied along segment line 1 causes modulator (3,1) to remain in a relaxed position. Thus, at the end of the fifth line time 60e, the 3×3 pixel array is in the state shown in FIG. 5A, and will remain in that state as long as the hold voltages are applied along the common lines, regardless of variations in the segment voltage which may occur when modulators along other common lines (not shown) are being addressed.

In the timing diagram of FIG. 5B, a given write procedure (e.g., line times 60a-60e) can include the use of either high hold and address voltages, or low hold and address voltages. Once the write procedure has been completed for a given common line (and the common voltage is set to the hold voltage having the same polarity as the actuation voltage), the pixel voltage remains within a given stability window, and does not pass through the relaxation window until a release voltage is applied on that common line. Furthermore, as each modulator is released as part of the write procedure prior to addressing the modulator, the actuation time of a modulator, rather than the release time, may determine the necessary line time. Specifically, in implementations in which the release time of a modulator is greater than the actuation time, the release voltage may be applied for longer than a single line time, as depicted in FIG. 5B. In some other implementations, voltages applied along common lines or segment lines may vary to account for variations in the actuation and release voltages of different modulators, such as modulators of different colors.

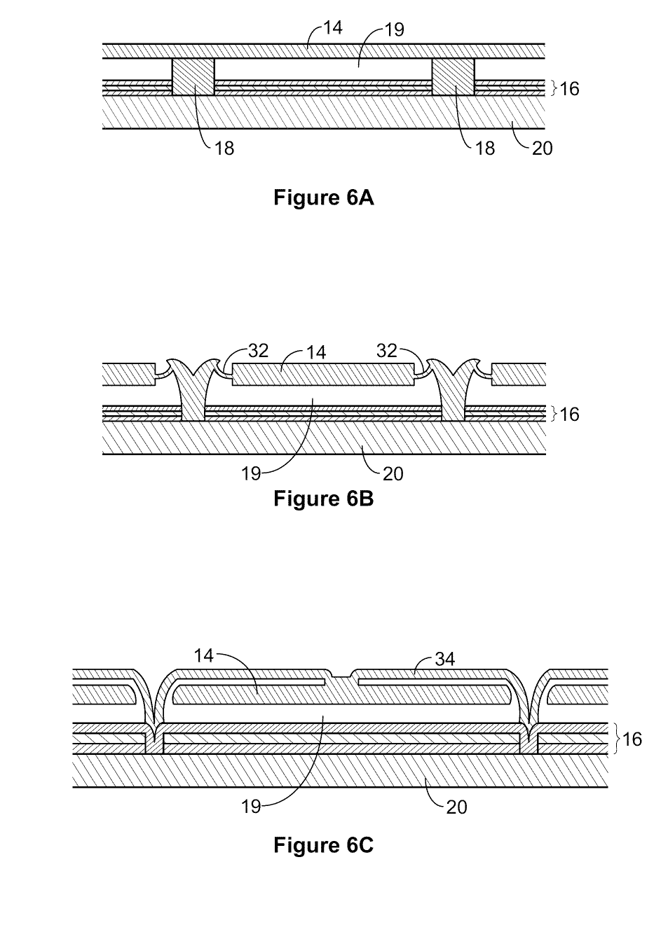

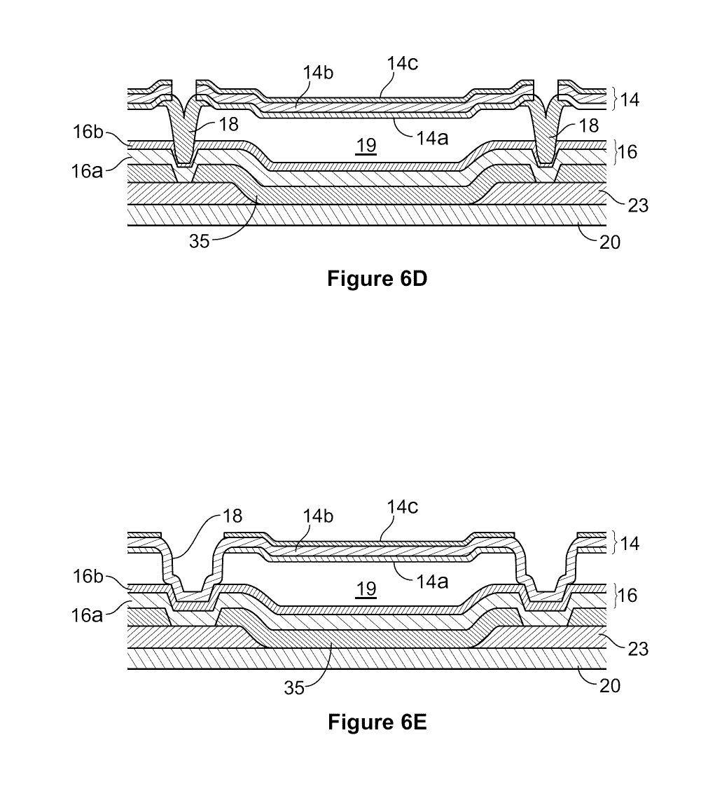

The details of the structure of interferometric modulators that operate in accordance with the principles set forth above may vary widely. For example, FIGS. 6A-6E show examples of cross-sections of varying implementations of interferometric modulators, including the movable reflective layer 14 and its supporting structures. FIG. 6A shows an example of a partial cross-section of the interferometric modulator display of FIG. 1, where a strip of metal material, e.g., the movable reflective layer 14 is deposited on supports 18 extending orthogonally from the substrate 20. In FIG. 6B, the movable reflective layer 14 of each IMOD is generally square or rectangular in shape and attached to supports at or near the corners, on tethers 32. In FIG. 6C, the movable reflective layer 14 is generally square or rectangular in shape and suspended from a deformable layer 34, which may include a flexible metal. The deformable layer 34 can connect, directly or indirectly, to the substrate 20 around the perimeter of the movable reflective layer 14. These connections are herein referred to as support posts. The implementation shown in FIG. 6C has additional benefits deriving from the decoupling of the optical functions of the movable reflective layer 14 from its mechanical functions, which are carried out by the deformable layer 34. This decoupling allows the structural design and materials used for the reflective layer 14 and those used for the deformable layer 34 to be optimized independently of one another.

FIG. 6D shows another example of an IMOD, where the movable reflective layer 14 includes a reflective sub-layer 14a. The movable reflective layer 14 rests on a support structure, such as support posts 18. The support posts 18 provide separation of the movable reflective layer 14 from the lower stationary electrode (e.g., part of the optical stack 16 in the illustrated IMOD) so that a gap 19 is formed between the movable reflective layer 14 and the optical stack 16, for example when the movable reflective layer 14 is in a relaxed position. The movable reflective layer 14 also can include a conductive layer 14c, which may be configured to serve as an electrode, and a support layer 14b. In this example, the conductive layer 14c is disposed on one side of the support layer 14b, distal from the substrate 20, and the reflective sub-layer 14a is disposed on the other side of the support layer 14b, proximal to the substrate 20. In some implementations, the reflective sub-layer 14a can be conductive and can be disposed between the support layer 14b and the optical stack 16. The support layer 14b can include one or more layers of a dielectric material, for example, silicon oxynitride (SiON) or silicon dioxide (SiO₂). In some implementations, the support layer 14b can be a stack of layers, such as, for example, a SiO₂/SiON/SiO₂ tri-layer stack. Either or both of the reflective sub-layer 14a and the conductive layer 14c can include, e.g., an aluminum (Al) alloy with about 0.5% copper (Cu), or another reflective metallic material. Employing conductive layers 14a, 14c above and below the dielectric support layer 14b can balance stresses and provide enhanced conduction. In some implementations, the reflective sub-layer 14a and the conductive layer 14c can be formed of different materials for a variety of design purposes, such as achieving specific stress profiles within the movable reflective layer 14.

As illustrated in FIG. 6D, some implementations also can include a black mask structure 23. The black mask structure 23 can be formed in optically inactive regions (e.g., between pixels or under posts 18) to absorb ambient or stray light. The black mask structure 23 also can improve the optical properties of a display device by inhibiting light from being reflected from or transmitted through inactive portions of the display, thereby increasing the contrast ratio. Additionally, the black mask structure 23 can be conductive and be configured to function as an electrical bussing layer. In some implementations, the row electrodes can be connected to the black mask structure 23 to reduce the resistance of the connected row electrode. The black mask structure 23 can be formed using a variety of methods, including deposition and patterning techniques. The black mask structure 23 can include one or more layers. For example, in some implementations, the black mask structure 23 includes a molybdenum-chromium (MoCr) layer that serves as an optical absorber, a layer, and an aluminum alloy that serves as a reflector and a bussing layer, with a thickness in the range of about 30-80 Å, 500-1000 Å, and 500-6000 Å, respectively. The one or more layers can be patterned using a variety of techniques, including photolithography and dry etching, including, for example, carbon tetrafluoride (CF₄) and/or oxygen (O₂) for the MoCr and SiO₂ layers and chlorine (Cl₂) and/or boron trichloride (BCl₃) for the aluminum alloy layer. In some implementations, the black mask 23 can be an etalon or interferometric stack structure. In such interferometric stack black mask structures 23, the conductive absorbers can be used to transmit or bus signals between lower, stationary electrodes in the optical stack 16 of each row or column. In some implementations, a spacer layer 35 can serve to generally electrically isolate the absorber layer 16a from the conductive layers in the black mask 23.

FIG. 6E shows another example of an IMOD, where the movable reflective layer 14 is self supporting. In contrast with FIG. 6D, the implementation of FIG. 6E does not include support posts 18. Instead, the movable reflective layer 14 contacts the underlying optical stack 16 at multiple locations, and the curvature of the movable reflective layer 14 provides sufficient support that the movable reflective layer 14 returns to the unactuated position of FIG. 6E when the voltage across the interferometric modulator is insufficient to cause actuation. The optical stack 16, which may contain a plurality of several different layers, is shown here for clarity including an optical absorber 16a, and a dielectric 16b. In some implementations, the optical absorber 16a may serve both as a fixed electrode and as a partially reflective layer.

In implementations such as those shown in FIGS. 6A-6E, the IMODs function as direct-view devices, in which images are viewed from the front side of the transparent substrate 20, e.g., the side opposite to that upon which the modulator is arranged. In these implementations, the back portions of the device (that is, any portion of the display device behind the movable reflective layer 14, including, for example, the deformable layer 34 illustrated in FIG. 6C) can be configured and operated upon without impacting or negatively affecting the image quality of the display device, because the reflective layer 14 optically shields those portions of the device. For example, in some implementations a bus structure (not illustrated) can be included behind the movable reflective layer 14 which provides the ability to separate the optical properties of the modulator from the electromechanical properties of the modulator, such as voltage addressing and the movements that result from such addressing. Additionally, the implementations of FIGS. 6A-6E can simplify processing, such as, e.g., patterning.

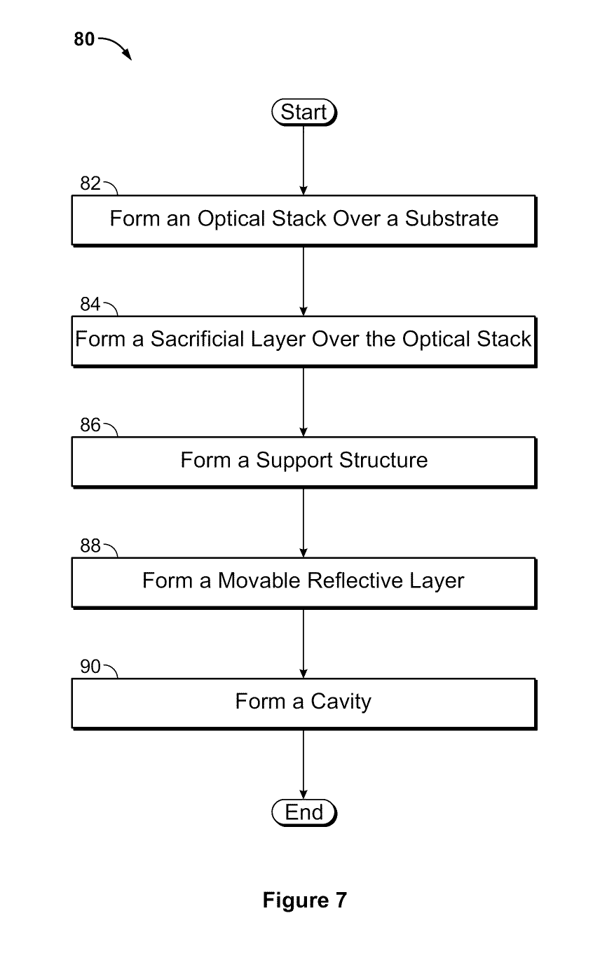

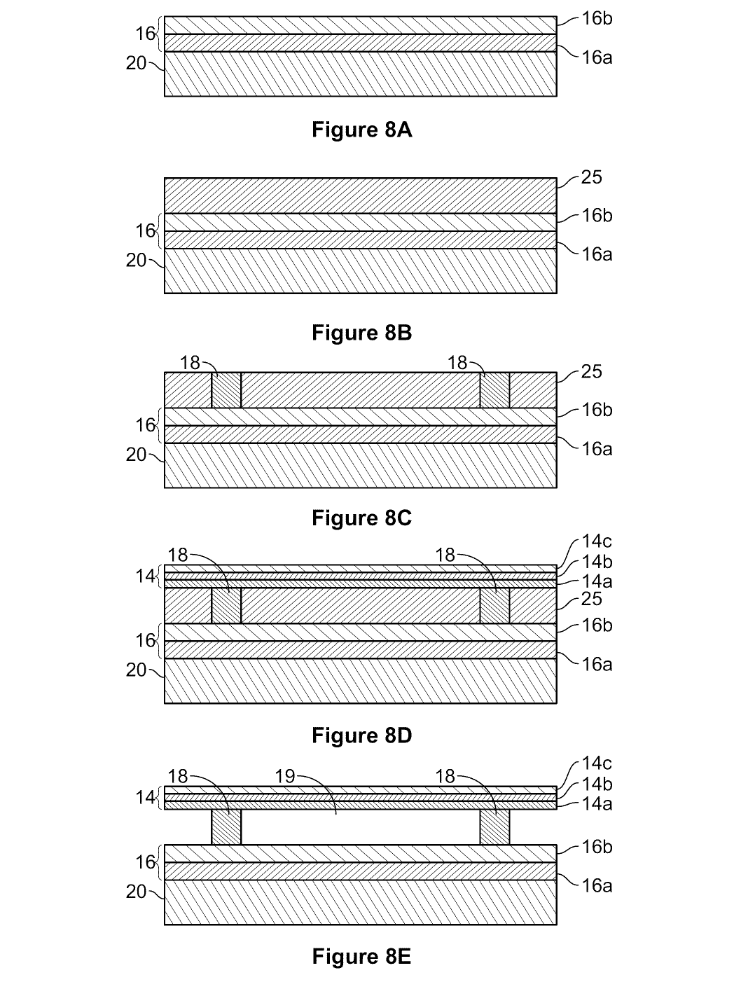

FIG. 7 shows an example of a flow diagram illustrating a manufacturing process 80 for an interferometric modulator, and FIGS. 8A-8E show examples of cross-sectional schematic illustrations of corresponding stages of such a manufacturing process 80. In some implementations, the manufacturing process 80 can be implemented to manufacture, e.g., interferometric modulators of the general type illustrated in FIGS. 1 and 6, in addition to other blocks not shown in FIG. 7. With reference to FIGS. 1, 6 and 7, the process 80 begins at block 82 with the formation of the optical stack 16 over the substrate 20. FIG. 8A illustrates such an optical stack 16 formed over the substrate 20. The substrate 20 may be a transparent substrate such as glass or plastic, it may be flexible or relatively stiff and unbending, and may have been subjected to prior preparation processes, e.g., cleaning, to facilitate efficient formation of the optical stack 16. As discussed above, the optical stack 16 can be electrically conductive, partially transparent and partially reflective and may be fabricated, for example, by depositing one or more layers having the desired properties onto the transparent substrate 20. In FIG. 8A, the optical stack 16 includes a multilayer structure having sub-layers 16a and 16b, although more or fewer sub-layers may be included in some other implementations. In some implementations, one of the sub-layers 16a, 16b can be configured with both optically absorptive and conductive properties, such as the combined conductor/absorber sub-layer 16a. Additionally, one or more of the sub-layers 16a, 16b can be patterned into parallel strips, and may form row electrodes in a display device. Such patterning can be performed by a masking and etching process or another suitable process known in the art. In some implementations, one of the sub-layers 16a, 16b can be an insulating or dielectric layer, such as sub-layer 16b that is deposited over one or more metal layers (e.g., one or more reflective and/or conductive layers). In addition, the optical stack 16 can be patterned into individual and parallel strips that form the rows of the display.

The process 80 continues at block 84 with the formation of a sacrificial layer 25 over the optical stack 16. The sacrificial layer 25 is later removed (e.g., at block 90) to form the cavity 19 and thus the sacrificial layer 25 is not shown in the resulting interferometric modulators 12 illustrated in FIG. 1. FIG. 8B illustrates a partially fabricated device including a sacrificial layer 25 formed over the optical stack 16. The formation of the sacrificial layer 25 over the optical stack 16 may include deposition of a xenon difluoride (XeF₂)-etchable material such as molybdenum (Mo) or amorphous silicon (a-Si), in a thickness selected to provide, after subsequent removal, a gap or cavity 19 (see also FIGS. 1 and 8E) having a desired design size. Deposition of the sacrificial material may be carried out using deposition techniques such as physical vapor deposition (PVD, e.g., sputtering), plasma-enhanced chemical vapor deposition (PECVD), thermal chemical vapor deposition (thermal CVD), or spin-coating.

The process 80 continues at block 86 with the formation of a support structure e.g., a post 18 as illustrated in FIGS. 1, 6 and 8C. The formation of the post 18 may include patterning the sacrificial layer 25 to form a support structure aperture, then depositing a material (e.g., a polymer or an inorganic material, e.g., silicon oxide) into the aperture to form the post 18, using a deposition method such as PVD, PECVD, thermal CVD, or spin-coating. In some implementations, the support structure aperture formed in the sacrificial layer can extend through both the sacrificial layer 25 and the optical stack 16 to the underlying substrate 20, so that the lower end of the post 18 contacts the substrate 20 as illustrated in FIG. 6A. Alternatively, as depicted in FIG. 8C, the aperture formed in the sacrificial layer 25 can extend through the sacrificial layer 25, but not through the optical stack 16. For example, FIG. 8E illustrates the lower ends of the support posts 18 in contact with an upper surface of the optical stack 16. The post 18, or other support structures, may be formed by depositing a layer of support structure material over the sacrificial layer 25 and patterning portions of the support structure material located away from apertures in the sacrificial layer 25. The support structures may be located within the apertures, as illustrated in FIG. 8C, but also can, at least partially, extend over a portion of the sacrificial layer 25. As noted above, the patterning of the sacrificial layer 25 and/or the support posts 18 can be performed by a patterning and etching process, but also may be performed by alternative etching methods.

The process 80 continues at block 88 with the formation of a movable reflective layer or membrane such as the movable reflective layer 14 illustrated in FIGS. 1, 6 and 8D. The movable reflective layer 14 may be formed by employing one or more deposition steps, e.g., reflective layer (e.g., aluminum, aluminum alloy) deposition, along with one or more patterning, masking, and/or etching steps. The movable reflective layer 14 can be electrically conductive, and referred to as an electrically conductive layer. In some implementations, the movable reflective layer 14 may include a plurality of sub-layers 14a, 14b, 14c as shown in FIG. 8D. In some implementations, one or more of the sub-layers, such as sub-layers 14a, 14c, may include highly reflective sub-layers selected for their optical properties, and another sub-layer 14b may include a mechanical sub-layer selected for its mechanical properties. Since the sacrificial layer 25 is still present in the partially fabricated interferometric modulator formed at block 88, the movable reflective layer 14 is typically not movable at this stage. A partially fabricated IMOD that contains a sacrificial layer 25 may also be referred to herein as an “unreleased” IMOD. As described above in connection with FIG. 1, the movable reflective layer 14 can be patterned into individual and parallel strips that form the columns of the display.

The process 80 continues at block 90 with the formation of a cavity, e.g., cavity 19 as illustrated in FIGS. 1, 6 and 8E. The cavity 19 may be formed by exposing the sacrificial material 25 (deposited at block 84) to an etchant. For example, an etchable sacrificial material such as Mo or amorphous Si may be removed by dry chemical etching, e.g., by exposing the sacrificial layer 25 to a gaseous or vaporous etchant, such as vapors derived from solid XeF₂ for a period of time that is effective to remove the desired amount of material, typically selectively removed relative to the structures surrounding the cavity 19. Other etching methods, e.g., wet etching and/or plasma etching, also may be used. Since the sacrificial layer 25 is removed during block 90, the movable reflective layer 14 is typically movable after this stage. After removal of the sacrificial material 25, the resulting fully or partially fabricated IMOD may be referred to herein as a “released” IMOD.

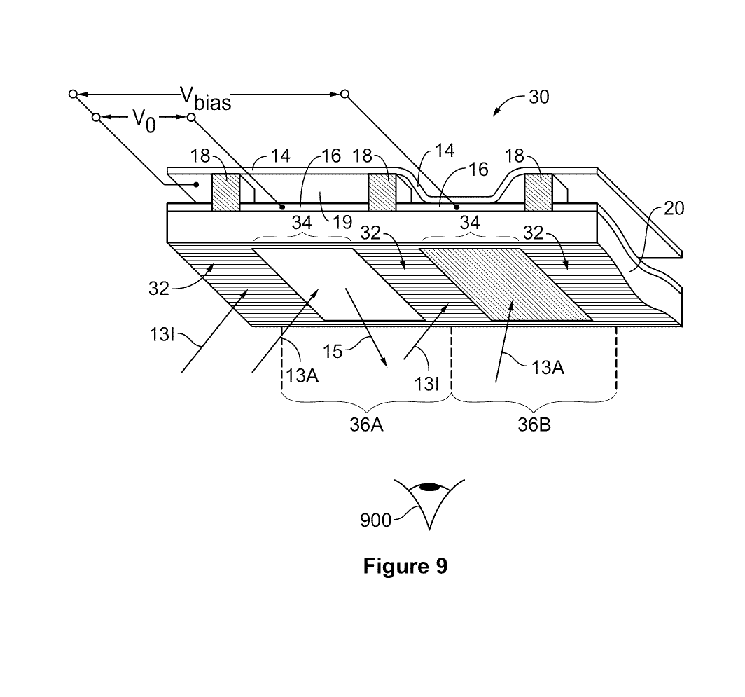

FIG. 9 shows an isometric view depicting an example of a display 30 including a first display element 36A and a second display element 36B in a series of display elements 36 of the display 30 including active regions 34 and inactive regions 32. The depicted portion of the display 30 in FIG. 9 includes two adjacent display elements 36, including a first display element 36A and a second display element 36B. As discussed above with reference to FIG. 1, in a display 30 in which the first and second display elements 36A and 36B include interferometric modulators, each display element 36A and 36B includes a movable reflective layer 14 and an optical stack 16. The optical stack 16 includes a partially reflective and partially transparent layer. As shown in FIG. 9, the orientation of the display 30 is illustrated relative to the position of a user eye 900.

Other types of display elements may also be used in the display 30 described herein. For example, the display 30 may include any of a variety of display elements, including a bi-stable display element, a tri-stable display element, an analog display element, a reflective display element, combinations thereof, and the like. The display 30 can be configured to include flat-panel display elements, such as plasma, EL, OLED, STN LCD, or TFT LCD, and/or non-flat-panel display elements, such as a CRT or other tube device. The display 30 can include movable interferometric modulator display elements, as described herein, or static interferometric modulators.

The applied voltage V₀, or the application of no voltage, across the movable reflective layer 14 and the actuation electrode (e.g., a combined conductor/absorber sub-layer 16a (e.g., as shown in FIGS. 8A-8E)) in the optical stack 16 of the first display element 36A is insufficient to cause actuation of the movable reflective layer 14 of the first display element 36A, so the movable reflective layer 14 of the first display element 36A is in a relaxed position or state or mode. With the movable reflective layer 14 in the relaxed position, the first display element 36A can reflect incident light. The light reflected by the first display element 36A in the relaxed position has a spectral reflectance having a first color corresponding at least partially to the height or distance of the gap 19. The applied voltage V_{bias} across the movable reflective layer 14 and the actuation electrode 16a in the optical stack 16 of the second display element 36B is sufficient to cause actuation of the movable reflective layer 14 of the second display element 36B, so the movable reflective layer 14 of the second display element 36B is in an actuated position or state or mode. With the movable reflective layer 14 in the actuated position, the second display element 36B can reflect incident light. The light reflected by the second display element 36B in the actuated position has a spectral reflectance having a second color different than the first color of the light reflected by the first display element 36A in the relaxed position. In some implementations, the second display element 36B can absorb (and not reflect) light in the actuated position.

The first display element 36A includes a portion of an active region 34 and a portion of an inactive region 32 of the array of the display elements 36. The inactive regions 32 are illustrated as the area including the horizontal hatching lines in FIG. 9. For example, the inactive regions 32 may correspond to an area of the first display element 36A including a post 18, deformed portions of the reflective layer 14, surrounding areas, etc., but are not limited thereto. Light 13A incident on the active region 34 of the display element 36A is reflected by the display element 36A to generate at least a portion of the image displayed by the display 30. Light 13I incident on the inactive regions 32 of the first display element 36A is not utilized by the display element 36A to generate the image. Light 13I may cause adverse effects such as reduced contrast, color gamut, etc. In an array of display elements 36, the display 30 includes a plurality of active regions 34 and a plurality of inactive regions 32. Inactive regions 32 and active regions 34 are not illustrated to scale throughout the disclosure, and the size of the active regions 34 and inactive regions 32 are schematically illustrated to show various concepts.

According to some implementations, an optical structure that increases the amount of light reflected by reflective display elements to generate an image is disclosed. The optical structure may be configured as an optical stack including multiple layers, or may be a single layer structure having different optical characteristics.

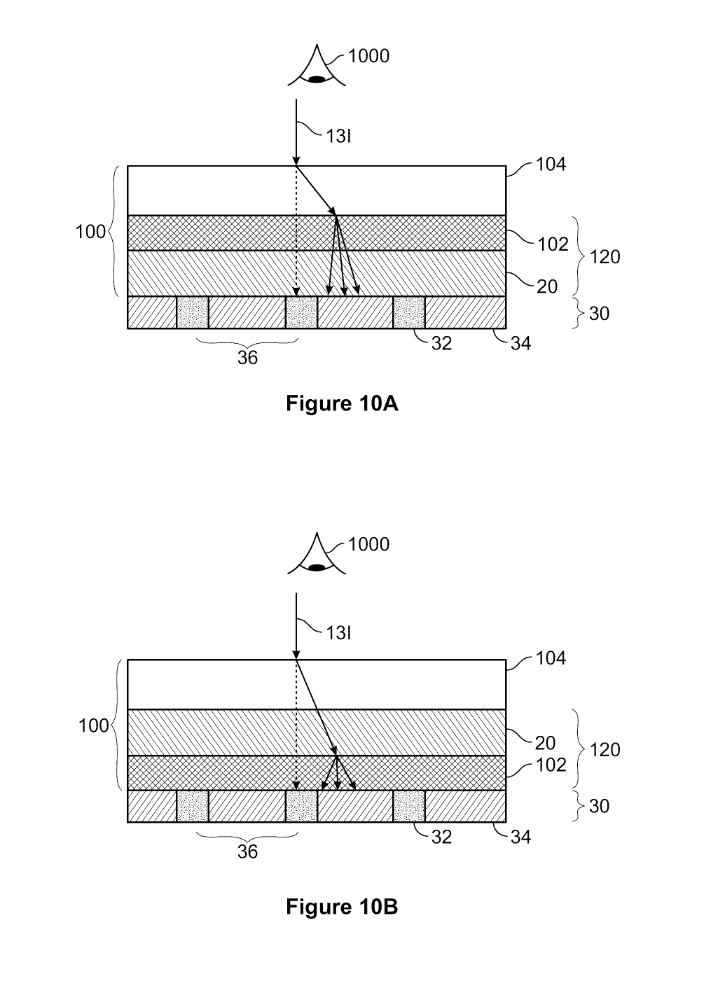

FIGS. 10A and 10B each illustrate a cross-section of an example of an optical structure 100 including a plurality of layers. As illustrated in FIGS. 10A and 10B, an optical structure 100 may be configured as a stack positioned above the display 30, the optical structure 100 including, for example: a steering layer 104; a diffuser 102, and a substrate 20. As illustrated in FIG. 10A, the plurality of layers of the optical structure 100 may be arranged with the diffuser 102 between the substrate 20 and the steering layer 104, and with the substrate 20 between the diffuser 102 and the display 30. As illustrated in FIG. 10B, the plurality of layers of the optical structure 100 may be arranged with the diffuser 102 between the display 30 and the substrate 20, and with the substrate 20 between the steering layer 104 and the diffuser 102. The substrate 20, the diffuser 102, and the steering layer 104 may be formed of materials including glass, plastic, polycarbonate, or the like. The substrate 20 and the diffuser 102 together may be referenced as a substrate/diffuser layer 120, for example when as described herein the substrate 20 and the diffuser 102 are integrated, part of the same layer, etc., in which case the plurality of layers of the optical structure 100 may be arranged with the substrate/diffuser 120 between the steering layer 104 and the display 30. The display 30 of FIGS. 10A and 10B is viewed by a user eye 1000 through the optical structure 100 (as illustrated, from the top). In FIGS. 1 and 9, the display 30 is viewed by a user eye 900 through the substrate 20 (as illustrated, from the bottom). Orientations of certain elements herein as being over, above, under, etc. will be understood with reference to the associated figures of the elements being described.

Light 13I incident on the steering layer 104 that would continue towards an inactive region 32 of the display 30 (e.g., as illustrated by the dotted arrows in FIGS. 10A and 10B) in the absence of the a steering layer 104 is directed towards an active region 34 of the display 30 (e.g., as illustrated by the solid arrows in FIGS. 10A and 10B). As illustrated in FIGS. 10A and 10B, the light 13I is directed directly or substantially directly (e.g., without reflection by other surfaces, optics, or layers of the optical structure 100) to at least one active region 34. The light 13I is steered towards the active regions 34 rather than continuing towards the inactive regions 32 by the steering layer 104. The light 13I is scattered by the diffuser 102 to produce scattered light incident on the active regions 34.

The steering layer 104 may be configured to direct substantially all light 13 that is incident on the optical structure 100 at a particular angle to at least one of the active regions 34 of the display 30. The steering layer 104 may include a plurality of steering features 103 configured to direct light away from inactive regions 32 and towards the active regions 34.

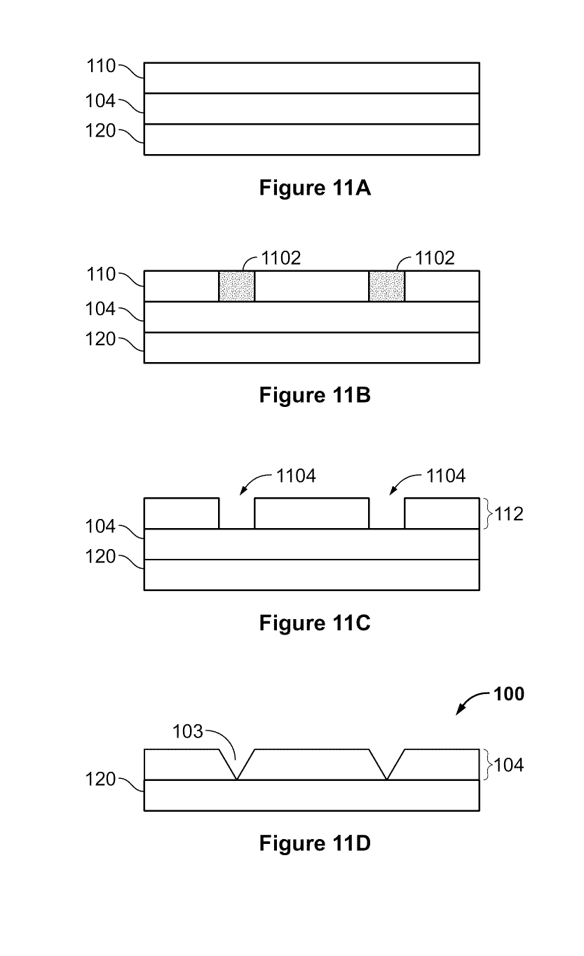

FIGS. 11A-11D illustrate a method of manufacturing steering features 103 of a steering layer 104 according to some implementations. As illustrated in FIG. 11A, a steering layer 104 may be formed over the substrate/diffuser layer 120. A photosensitive material layer 110 (e.g., photoresist) may be formed over the steering layer 104. A pattern is formed in the photosensitive material layer 110 based on the exposure or non-exposure of portions 1102 of the photosensitive material layer 110 to light (e.g., ultraviolet light, an electron beam, etc.). The exposed or non-exposed areas may be removed (e.g., using a developing solution) to form recessed portions 1104 in the photosensitive material layer 110, as illustrated in FIG. 11C, thereby creating a mask layer 112. Certain baking, adhesion, and other steps have been omitted for clarity. The recessed portions 1104 may be exposed to an etching process (e.g., a chemical or ion etching process) to form the steering features 103 or a master substrate for forming the steering features 103, as illustrated in FIG. 11D.

In some implementations, the steering layer 104 may be formed of a plastic material (e.g., PMMA, acrylic, or polyester, or the like). The steering features 103 can be manufactured in the steering layer 104 by various processes, including, among others, injection molding, heat embossing, UV curing, and the like. The steering features 103 may be manufactured by flat panel replication and/or a roll imprinting method using a master substrate. The steering layer 104 may be formed separately from the substrate 20, the diffuser 102, and/or the substrate/diffuser layer 120, and subsequently laminated on the on the substrate/diffuser layer 120 to form the optical structure 100. The steering layer 104 may be formed as part of the substrate 20, and the steering features 103 may be formed (e.g., by ion etching, chemical etching, laser cutting, combinations thereof, and the like) in a surface of a separate layer or in a surface of the substrate 20. A planarization layer (not shown) may be formed above the steering features 103 of the steering layer 104. The planarization layer may have a refractive index that is different than the refractive index of the steering layer 104 and/or the substrate 20 and/or the substrate/diffuser 120 (e.g., the binder of a volume diffuser 106 described herein).

The dimensions of the steering features 103 may be determined at least partially based on a thickness of the substrate 20 and the steering layer 104. According to some implementations, the thickness of the steering layer 104 may be between about 1 μm and about 5 μm. According to some implementations, the thickness of the substrate 20 may be between about 100 μm and about 300 μm. The thickness of the substrate 20 may be determined based at least partially on the dimensions of the steering features 103. The dimensions of the steering features 103 may be determined based at least partially on an angle of incidence of the light 13 and/or an angle of reflectance of the light 15 reflected by the display 30. The angle of reflectance of the light 15 that is reflected by the display 30 may correspond at least partially to a position at which a viewer views a displayed image generated by the display 30. The dimensions of the steering features 103 may be determined at least partially as a function of an incident angle of light, the thickness of the steering layer 104, the thickness of the substrate 20, dimensions of active areas 34, dimensions of inactive areas 32, a viewer's angle for receiving reflected light 15 from the display 30, combinations thereof, and the like.

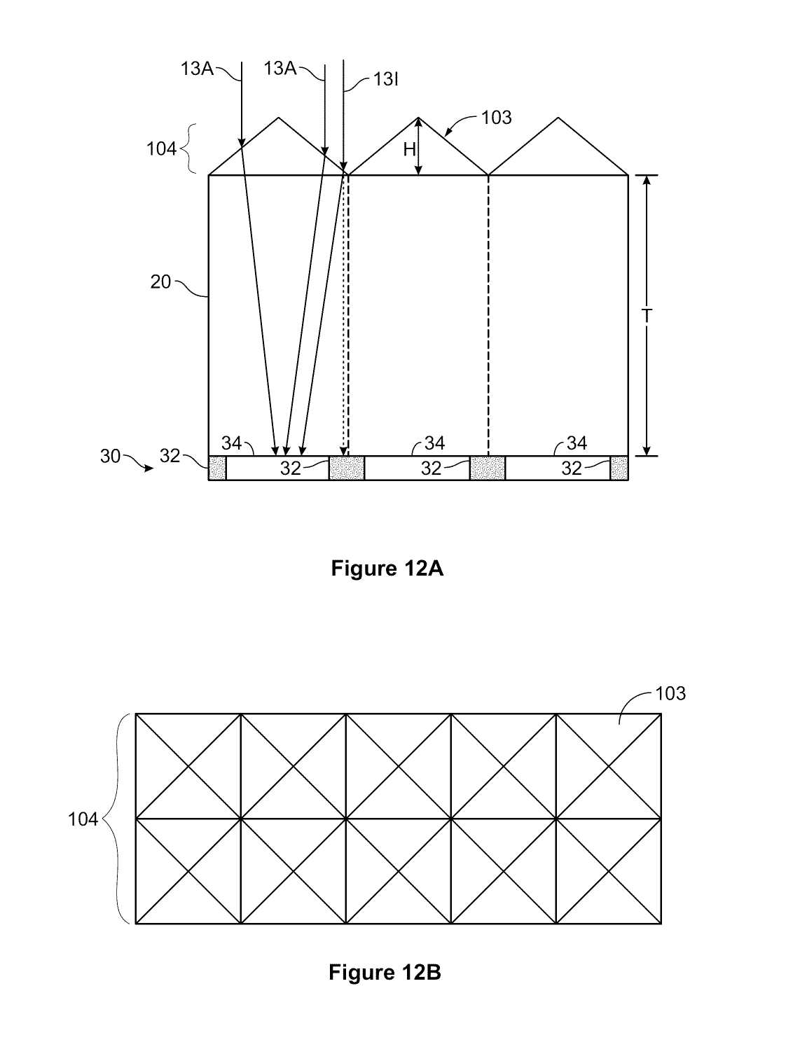

The steering features 103 may have a variety of different shapes according to various implementations. FIG. 12A illustrates a cross-sectional view of an example of a steering layer 104 including steering features 103 configured as one-dimensional prisms. For example, the steering features 103 may include two tilted sides extending into and/or out of the direction of the page. Each of the steering features 103 may include a base that is adjacent to the base of at least one other steering feature 103. A steering feature 103 may be configured to have a base that is adjacent the base of another steering feature 103 along substantially all of one dimension (e.g., a length or width) of the display 30, or along substantially all of one dimension of a panel of the display 30. As illustrated in FIG. 12A, the steering features 103 have a height H and the substrate 20 has a thickness T. The height H may correspond to a thickness of the steering layer, and may be between about 1 μm and about 5 μm. As discussed above, the thickness T of the substrate 20 may be between about 100 μm and about 300 μm. The height H may decrease as the thickness T increases. For prismatic steering features having the same width, a steering angle (e.g., a difference in the angle between incident light measured with respect to normal incidence on the display 30 and an angle of steered light measured with respect to normal incidence on the display 30) may increase as height H increases and may decrease as the height H decreases and/or may decrease as the thickness T increases and may increase as the thickness T decreases. While the dimensions of the substrate 20 and the thickness of the steering layer 104 may not be illustrated in each of the implementations of steering layers 104 described herein, a skilled artisan will recognize that these dimensions may be applicable to the other implementations of steering layers 104 illustrated and described herein. As discussed above, the dimensions of the steering features 103 may be determined at least partially as a function of an incident angle of light, the height H, the thickness T, dimensions of active areas 34, dimensions of inactive areas 32, a viewer's angle for receiving reflected light 15 from the display 30, combinations thereof, and the like.

In the example implementation illustrated in FIG. 12A, the edges of adjacent prisms 103 are centered about the centers of the inactive regions 32, as illustrated by the dashed lines. Light 13I propagating towards the inactive regions 32 (e.g., as illustrated by the dotted arrows in FIG. 12A) is directed or steered by the steering features 103 (e.g., by refraction of the light 13I) to the active regions 34 of the display 30. Light 13 propagating towards the active regions 34 (e.g., as illustrated by the solid lines in FIG. 12A) is also directed or steered by the steering features 103 (e.g., by refraction of the light 13I), and continues to propagate towards the active regions 34.

As illustrated in FIG. 12A, light 13I that would be incident on the inactive regions 32 in the absence of a steering layer 104 is directed by the steering features 103 away from the inactive regions 32 and towards the active regions 34. Since the active regions 34 receive the light 13I that otherwise would have been directed towards the inactive regions 32 as well as the light 13A directed towards the active regions 34 with or without the steering layer 104, the active regions 34 are able to reflect more light than without the steering layer 104, and the brightness of the active regions 34 may be increased. Since the active regions 34 receive the light 13I that otherwise would have been directed towards the inactive regions 32, rather than the light 13I being reflected and/or absorbed by the inactive regions 32, the active regions 34 are able to reflect the light 13I, and the contrast between the active regions 34 and the inactive regions 32 may be enhanced. One or both of these advantages may be achieved by other devices described herein in which steering features 103 direct light away from inactive regions 32 and towards active regions 34.

FIG. 12B illustrates a top view of an example implementation of a steering layer 104 including steering features 103 configured as a two-dimensional prismatic array in a steering layer 104. For example, each of the steering features 103 illustrated in FIG. 12B includes four congruent triangular sides and a base. The base of each of the steering features 103 may be adjacent to at least one other steering feature 103 in the array. Based on the position of the steering features 103 relative to the display 30, some of the steering features 103 may have a base that is adjacent to four other steering features 103. A display 30 may include an array of steering features 103 corresponding to an array of display elements 36 to direct light away from inactive regions 32 and towards active regions 34 of the display 30. For example, display elements 36 (not shown) under the steering layer 104 in FIG. 12B may be rectangular or square. For another example, a cross-section across the middle of the steering layer 104 in FIG. 12B may look like FIG. 12A, in which the edges of adjacent steering features 103 are centered about the centers of the inactive regions 32.

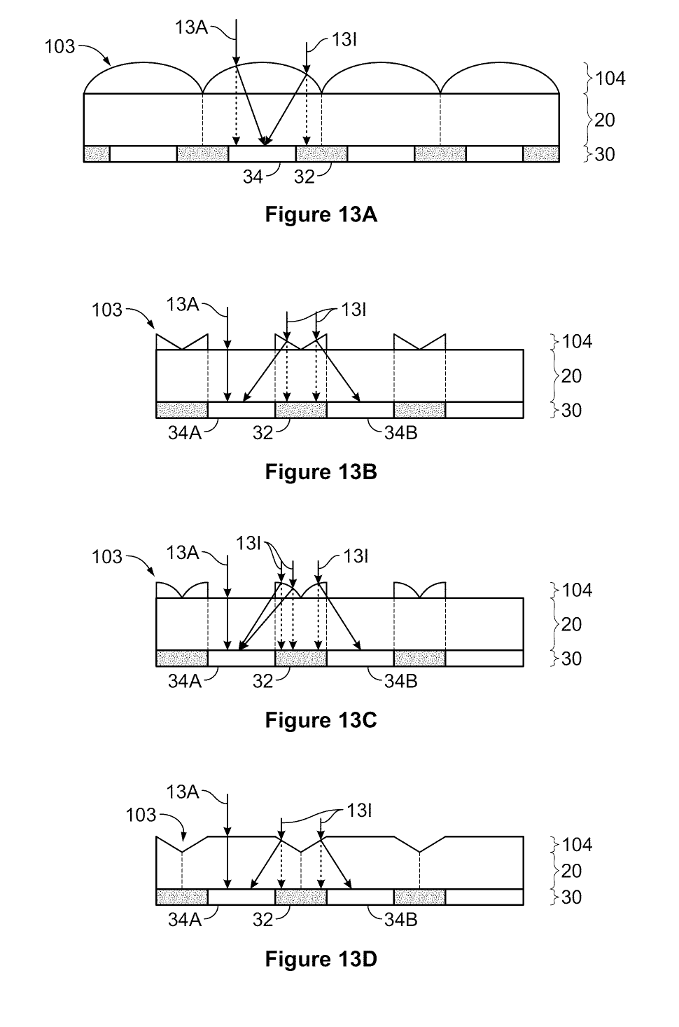

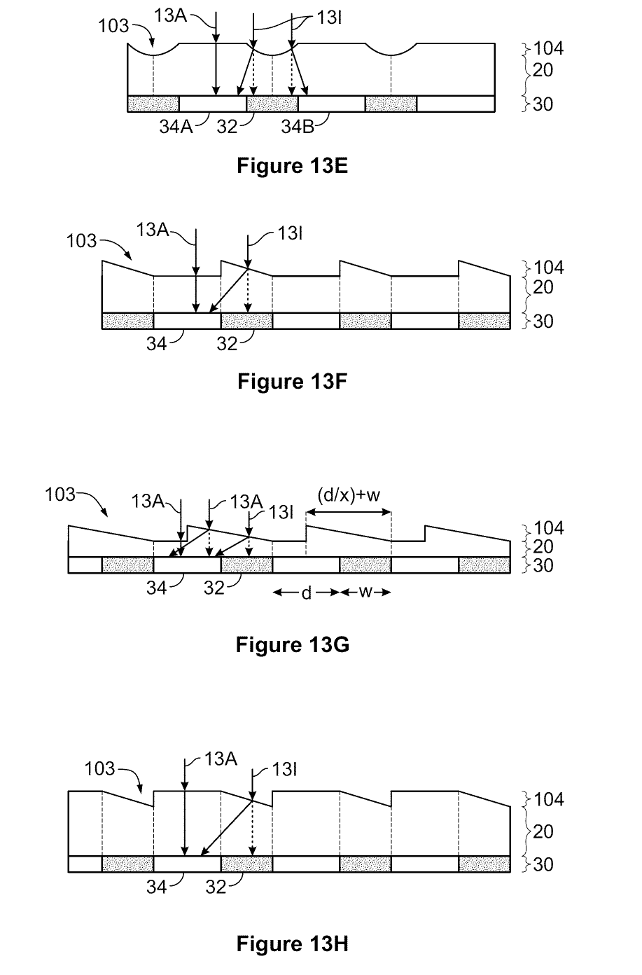

According to some implementations, other configurations for steering features 103 in the steering layer 104 are also possible. FIGS. 13A-13I illustrate cross-sectional views of various configurations for steering features 103 according to some implementations. The steering features 103 illustrated in FIGS. 13A-13I are configured to direct light 13I away from the inactive regions 32 and towards the active regions 34.

FIG. 13A illustrates an example implementation of a steering layer 104 including steering features 103 configured as a lens array. The lens array includes steering features having a convex surface that is symmetrical with respect to a center of the inactive regions 32 (e.g., as illustrated by the dashed lines in FIG. 13A). In contrast to the prisms illustrated in FIGS. 12A and 12B, in which light 13I that would be incident on the inactive regions 32 in the absence of a steering layer 104 is redirected towards various parts of the active regions 34, light 13I that would be incident on the inactive regions 32 in the absence of a steering layer 104 is redirected towards a center of the active regions 34. Light 13A that would be incident on outer areas of the active regions 34 is redirected towards the center of the active regions 34. The curvature of each lens may be determined at least partially as a function of the position of each active region 34 at which incident light 13 is to be focused. As a result, the steering features 103 redirect all incident light 13 towards regions near or proximate to centers of the active regions 34, which may enhance a contrast ratio between the active regions 34 and the inactive regions 32 of the display 30 and/or counter residual diffusion (e.g., due to diffraction and/or finite focus of the display 30).

FIG. 13B illustrates an example implementation of a steering layer 104 including steering features 103 configured as a residual prism array concentrated over areas corresponding to the inactive regions 32. As illustrated, the steering features 103 of FIG. 13B include two symmetrical right triangle portions. Each right triangle portion includes an edge that is aligned with an edge of an inactive region 32. In some implementations, an edge of the right triangle portions is offset from the edge of the inactive region 32. The amount of offset may be based at least partially on the area of each of the inactive regions 32 and the combined thickness of the display 30, the substrate 120, the steering layer 104, and the diffuser 102 (if separately provided). In comparison to the prismatic steering features 103 discussed with respect to FIGS. 12A and 12B, no steering features 103 are positioned above the active regions 34, and light 13A incident on the active regions 34 that would continue towards the active regions 34 without a steering layer 104 is not redirected by the steering layer 104 (e.g., as illustrated by solid lines in FIG. 13B). Light 13I incident on the steering features 103 that would continue towards an inactive region 32 in the absence of a steering layer 104 (e.g., as illustrated by dotted arrows in FIG. 13B) is redirected towards the active regions 34. As illustrated in FIG. 13B, for each steering feature 103, light 13I incident on the inactive regions 32 may be redirected to one of the active regions 34 that are adjacent to the inactive region 32 based on the incidence of the light 13I on the steering feature 103. For example, as illustrated in FIG. 13B, light 13I that is incident on an inactive region 32 may be directed either towards an active region 34A (as illustrated, to the left), or to an active region 34B (as illustrated, to the right), based on the position at which the light 13I is incident on steering feature 103. The light 13I that is directed by the steering features 103 may be substantially distributed across the surface of the active regions 34.

FIG. 13C illustrates an example implementation of a steering layer 104 including steering features 103 configured as a residual lenslet array concentrated over areas corresponding to the inactive regions 32. Each steering feature 103 of FIG. 13C includes two symmetrical portions, each having an edge that is aligned with an edge of an inactive region 32. In some implementations, an edge of the right triangle portions is offset from the edge of the inactive region 32 based at least partially on the areas of the inactive regions 32 and the combined thickness of the layers. In comparison to the lens array discussed with respect to FIG. 13A, in which light 13A that would be incident on the active regions 34 in the absence of a steering layer 104 is redirected towards centers of the active regions 34, there are no steering features 103 above the active regions 34, and light 13A incident on the active regions 34 is not redirected. Light 13I incident on the steering features 103 that would continue towards an inactive region 32 in the absence of a steering layer 104 (e.g., as illustrated by dotted arrows in FIG. 13B) is redirected towards the active regions 34. The angle of curvature of each residual lenslet may be a function of an area of the active regions 34 at which light is redirected. As illustrated in FIG. 13C, light 13I that is incident on an inactive region 32 may be directed either towards an active region 34A (as illustrated, to the left), or to an active region 34B (as illustrated, to the right), based on the position at which the light 13I is incident on steering features 103. Due to the curvature of the steering features 103 of FIG. 13C, light 13I is directed towards a central area of the active regions 34. For example, light 13I that is incident proximate to the central portion of the steering feature 103 is directed at a greater angle than light 13I that is incident proximate to the edges of the steering features 103.

FIG. 13D illustrates an example implementation of a steering layer 104 including steering features 103 configured as a partial reverse prismatic array concentrated over areas corresponding to the inactive regions 32. Each of the steering features 103 of FIG. 13D is symmetric about a substantially central portion of an inactive region 32 (e.g., as illustrated by dashed lines in FIG. 13D). Although the steering layer 104 includes material over the active regions 34, that material is planar, and light 13A that would be incident on the active regions 34 in the absence of a steering layer 104 is not redirected. Light 13I incident on the steering features 103 that would continue towards an inactive region 32 (e.g., as illustrated by dotted arrows in FIG. 13D) is redirected towards the active regions 34. As illustrated in FIG. 13D, light 13I that is incident on an inactive region 32 may be directed either towards an active region 34A (as illustrated, to the left), or to an active region 34B (as illustrated, to the right), based on the position at which the light 13I is incident on steering feature 103. The light 13I that is directed by the steering features 103 may be substantially distributed across the surface of the active regions 34.

FIG. 13E illustrates an example implementation of a steering layer 104 including steering features 103 configured as a partial negative lenslet array. Each of the steering features 103 of FIG. 13E is symmetric about a substantially central portion of an inactive region 32 (e.g., as illustrated by dashed lines in FIG. 13E). Although the steering layer 104 includes material over the active regions 34, that material is planar, and light that would be incident on the active regions 34 in the absence of a steering layer 104 is not redirected. Light 13I incident on the steering features 103 that would continue towards an inactive region 32 in the absence of a steering layer 104 (e.g., as illustrated by dotted arrows in FIG. 13E) is redirected towards the active regions 34. As illustrated in FIG. 13E, light 13I that is incident on an inactive region 32 may be directed either towards an active region 34A (as illustrated, to the left), or to an active region 34B (as illustrated, to the right), based on the position at which the light 13I is incident on steering feature 103. The angle of curvature of each partial negative lenslet may be a function of an area of the active regions 34 at which light is to be redirected. For example, light 13I that is incident proximate to the central portion of the steering feature 103 may be directed at a smaller angle than light 13I that is incident proximate to the edges of the steering features 103. If the width of the steering feature 103 is smaller than the width of the inactive region 32, light spreading may be less efficient. If the width of the steering feature 103 is larger than the width of the inactive region 32, some light that would be incident on an active region 34 may be redirected to an inactive region 32.

The steering features 103 described above with reference to FIGS. 13A, 13C, and 13E (e.g., a lens array, a residual lenslet array, and a partial negative lenslet array) are configured to direct different rays of light 13 at different angles based on a position of the steering features 103 at which the ray of light 13 is incident on the steering features 103. For example, in the implementations of FIGS. 13A, 13C, and 13I, a ray of light 13 that is incident on an outer area of a steering feature 103 will be directed to a different degree than a ray of light 13 that is incident on an inner area of a steering feature 103. Further, reflected light may be directed at different angles based on a position at which the reflected light is incident on the steering features 103, thereby increasing the viewing angle of the display 30. Light incident on the center of the steering feature 103 may not be redirected, although other light 13I that would otherwise be incited on the inactive region 32 may be redirected depending at least partially on lens curvature, stack thicknesses, and/or angle of incidence.

While not illustrated, any of the steering features 103 described above with reference to FIGS. 13A-13E may also be implemented as two-dimensional steering features 103, similar to the steering features 103 described with reference to the two-dimensional prismatic array of FIG. 12B.

FIG. 13F illustrates an example implementation of a steering layer 104 including steering features 103 configured as a residual uni-directional array. The residual uni-directional array is concentrated over areas corresponding to the inactive regions 32, and each steering feature 103 has an edge aligned with an inactive region 32 and an end aligned with the other edge of the inactive region 32 (e.g., as illustrated by as illustrated by dashed lines in FIG. 13F). In comparison to the steering features 103 discussed with respect to FIGS. 13B and 13D, in which the steering features 103 redirect light that would that would be incident on the inactive areas 30 in the absence of a steering layer 104 in a plurality of directions (as illustrated in FIGS. 13B and 13D, to the left and to the right), the steering features 103 in FIG. 13F redirect light that would be incident on the inactive areas 32 in the absence of a steering layer 104 in a single direction (as illustrated in FIG. 13F, to the left). As in FIGS. 13B and 13D, there are no steering features 103 above the active regions 34, and light incident on the active regions 34 is not redirected.

FIG. 13G illustrates an example implementation of a steering layer 104 including steering features 103 configured as a half prismatic array concentrated over areas corresponding to the inactive regions 32, as well as over parts of the active regions 34. For example, the steering features 103 may include half prisms including a first portion completely covering an inactive region 32 and a second portion covering at least part (but not all) of an active region 34. Light 13I incident on the steering layer 104 that would continue towards an inactive region 32 of the display 30 in the absence of a steering layer 104 (e.g., as illustrated by the dotted arrows in FIG. 13G) is directed towards an active region 34 of the display 30 (e.g., as illustrated by the solid arrows in FIG. 13G). For active regions 34 having widths d and inactive regions 32 having widths w, the widths of the steering features 103 are equal to (d/x)+w, where x is a predetermined value greater than 1. By varying the value of x, the width of the steering features may vary relative to the width of an active region 34. The portion of the active regions that is covered by steering features 103 may be adjusted based on the value of x. For example, by increasing x, a smaller portion of an active region 34 is covered by a corresponding steering feature 103. As one non-limiting example, for x=2, the steering features 103 are configured to cover half of the active regions 34. In this example, an edge of a steering feature 103 is aligned with the center of the active region 34, and the other end of the steering feature 103 is aligned with an edge of the inactive region 32 (e.g., as illustrated by dashed lines in FIG. 13G).

The remaining portions of the steering layer 104 over the active regions 34 as illustrated in FIG. 13G include gaps or planar surfaces between the steering features 103. In comparison to the uni-directional steering features 103 discussed with respect to FIG. 13F, the second portions of the steering features 103 are positioned over a part of the active regions 34, and light incident on those second portions (e.g., as illustrated by light 13A incident on the slanted surface of a steering feature 103) is redirected to other parts of the active regions 34. The half-prismatic steering features of FIG. 13G may be advantageous for a display device that is positioned in an environment in which ambient light is concentrated on one side of the display device. In the example of FIG. 13G, the steering features 103 may advantageously direct ambient light that originates from a region to the right side of the display device as illustrated in FIG. 13G to active regions 34 of the display 30.

FIG. 13H illustrates an example implementation of a steering layer 104 including steering features 103 configured as a reverse trapezoidal array. The steering features 103 have an obtuse edge that is aligned with an edge of an inactive region 32, and an acute edge or a point that is aligned with another edge of the inactive region 32 (e.g., as illustrated by the dashed lines in FIG. 13H). The steering features 103 are concentrated over the inactive region 32. Although the steering layer 104 includes material over the active regions 34, that material is planar, and light that would be incident on the active regions 34 in the absence of a steering layer 104 is not redirected. Light 13I incident on the steering layer 104 that would continue towards an inactive region 32 of the display 30 in the absence of a steering layer 104 (e.g., as illustrated by the dotted arrows in FIGS. 13F) is directed towards an active region 34 of the display 30 in only one direction (e.g., to the left as illustrated in FIGS. 13H).

FIG. 13I illustrates an example implementation of a steering layer 104 including steering features 103 configured as a reverse fractional prismatic array. The reverse fractional prismatic array may include a first portion over the inactive regions 32 and a second portion partially covering at least part (but not all) of an active region 34. For an active region 34 having a width d and an inactive region 32 having a width w, the width of the steering features 103 is equal to (d/x)+w, where x is a predetermined value greater than 1. As discussed above with reference to FIG. 13G, by varying the value of x, the portion of the active regions 34 covered by the steering features 103 may be varied. As one non-limiting example, for x=2, the steering features 103 are configured to cover half of the active regions 34. In this example, an edge of a steering feature 103 is aligned with the center of the active region 34, and the other end of the steering feature 103 is aligned with an edge of the inactive region 32 (e.g., as illustrated by dashed lines in FIG. 13I). Light 13I that is incident on the first portions of the steering features 103 and would propagate to the inactive regions 32 in the absence of a steering layer 104 (e.g., as illustrated by the right dotted arrow in FIG. 13I) is redirected towards the active regions 34. Light 13A that is incident on the second portions of the steering features (e.g., as illustrated by the solid arrow 13A incident on the steering feature 103) that would propagate towards an active region 34 in the absence of a steering layer 104 (e.g., as indicated by dotted line extending from light 13A in FIG. 13I) is directed to other areas of the active regions 34. The remaining portions of the steering layer 104 over the active regions 34 include gaps or planar surfaces between the steering features 103. Although the steering layer 104 includes material over the active regions 34 other than the second portions, that material is planar, and light that would be incident on the active regions 34 other than the second portions in the absence of a steering layer 104 is not redirected.

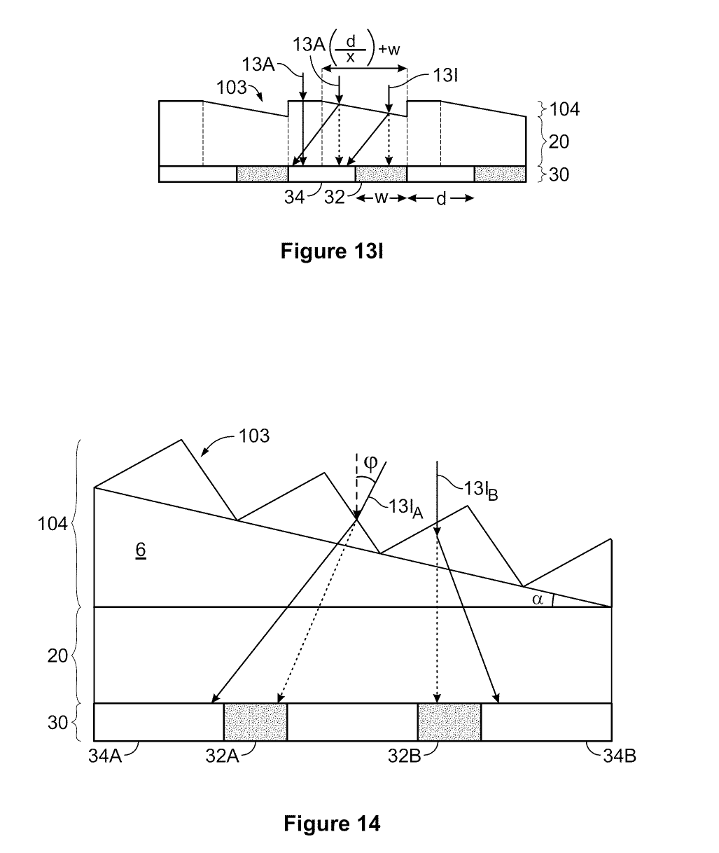

The configurations of steering features 103 as described above with reference to FIGS. 12A-12B, and 13A-13I, are illustrated with reference to light having normal incidence. In some implementations, light may be incident on a display 30 at angles other than normal. For example, based on the position of the display 30 and the direction of incident light (e.g., ambient light and/or light from a light source), the angle at which a majority of light is incident on the display may be other than normal. To adjust for a variation in the angle of incidence, any of the configurations described herein (e.g., the configurations illustrated in FIGS. 12A-13I or modifications thereof) may be implemented on a slanted edge surface. FIG. 14 illustrates a steering layer 104 including steering features 103 and a slanted wedge 6 according to some implementations. In the example illustrated in FIG. 14, a prismatic array (e.g., similar to the prismatic array of FIG. 12A or 12B) is provided on a surface of a slanted wedge 6 having an angle α. The steering features 103 are configured to steer light towards the active regions 34. By forming the steering features 103 on a surface of a slanted wedge 6, light incident at angles other than the normal can be steered toward the active regions 34. For example, as illustrated in FIG. 14, light 13I_{A} incident at an angle φ from the normal that would propagate to an inactive region 32A in the absence of a steering layer 104 (e.g., as illustrated by the dotted arrow incident on inactive region 32A in FIG. 14) is steered away from the inactive region 32A and towards the active region 34A. Light 13I_{B} having normal incidence that would propagate towards an inactive region 32B in the absence of a steering layer 104 (e.g., as illustrated by the dotted line incident on the inactive region 32B in FIG. 14) is steered away from the inactive region 32B and towards the active region 34B. The angle α may be determined, for example, at least partially as a function of an incident angle φ of light that is incident on the display 30 and/or the type of steering features 103. In some implementations, the angle α is between about 10° and about 30° . In some implementations, the angle φ is between about 0° and about 45°, and in some implementations between about 0° and about 30°.

The steering layer 104 may comprise a slanted wedge 6 and not steering features 103. Light 13I_{A} and 13I_{B} may be redirected only by the surface of the slanted wedge 6 towards active regions 34. The surface of the slanted wedge 6 may direct light that would propagate towards active regions 34 in the absence of a steering layer 104 towards inactive regions 32, but may advantageously change viewing angle and brightness for light having incidence other than normal. For example, for a display 30 having a majority of light that is incident on the display 30 at a particular angle, the steering features 103 formed on a slanted wedge 6 direct the majority of light that is incident at the particular angle towards active regions 34 of the display 30. Further, the steering features 103 that are formed on a slanted wedge 6 may be configured to redirect reflected light at a particular viewer's angle based on the angle α of the slanted wedge 6.

Reflective displays 30 are generally specular in nature, such that they can be sensitive to the direction of incoming light and the viewing angle. The viewing angle of a reflective display 30 may be adjusted by incorporating a diffuser 102 into the optical structure 100. The diffuser 102 can, for example, scatter light incident on the display 30 and/or light reflected from the display 30 over a larger range of angles, thereby decreasing the sensitivity of the viewing angle to the direction of incoming light. By incorporating a diffuser 102, the viewing angle of a reflective display 30 may be increased by about 10 degrees to about 30 degrees versus a reflective display 30 that does not include the diffuser 102. Other angles are also possible, although blur, stack thickness, other optical components or films, etc. may be considered.

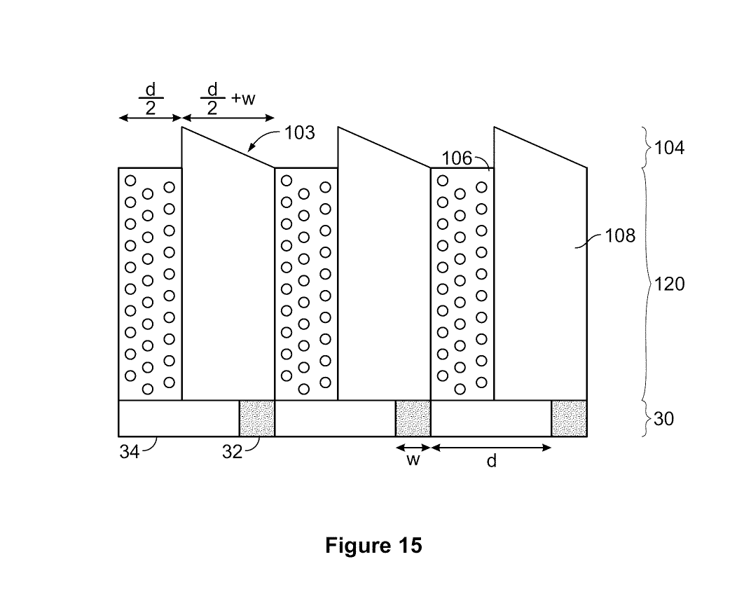

FIG. 15 illustrates a volume diffuser integrated in a manufactured substrate/diffuser 120 according to some implementations. As illustrated in FIG. 15, the substrate/diffuser 120 includes substrate material areas 108 (e.g., including glass, polycarbonate, etc.) interspersed with volume diffusing areas 106 (e.g., including a binder and scattering elements). Each volume diffusing area 106 may be situated above a portion of an active region 34. The volume diffusing areas 106 are configured to scatter light that propagates through the volume diffusing areas 106. For a display 30 including active regions 34 having a width d and inactive regions 32 having a width w, the volume diffusing areas 106 may have a width of d/2. The portion that is covered by the volume diffusing areas 106 is not limited to that illustrated in FIG. 15. For example, the volume diffusing areas 106 may have a width greater than d/2 or less than d/2. By forming a diffuser as part of the substrate/diffuser 120, the proximity of the diffuser to the display 30 may be increased, and the scattered light may more directly reflect from the display 30.

As illustrated in FIG. 15, the steering features 103 may include a half-prismatic array similar to that described herein with reference to FIG. 13G. Each steering feature 103 may cover an inactive region 32 and a portion of an active region 34, and may have a width equal to d/2+w. As discussed herein with reference to FIG. 13G, the width for the steering features 103 may be variable. Other steering features 103 described herein are also possible.

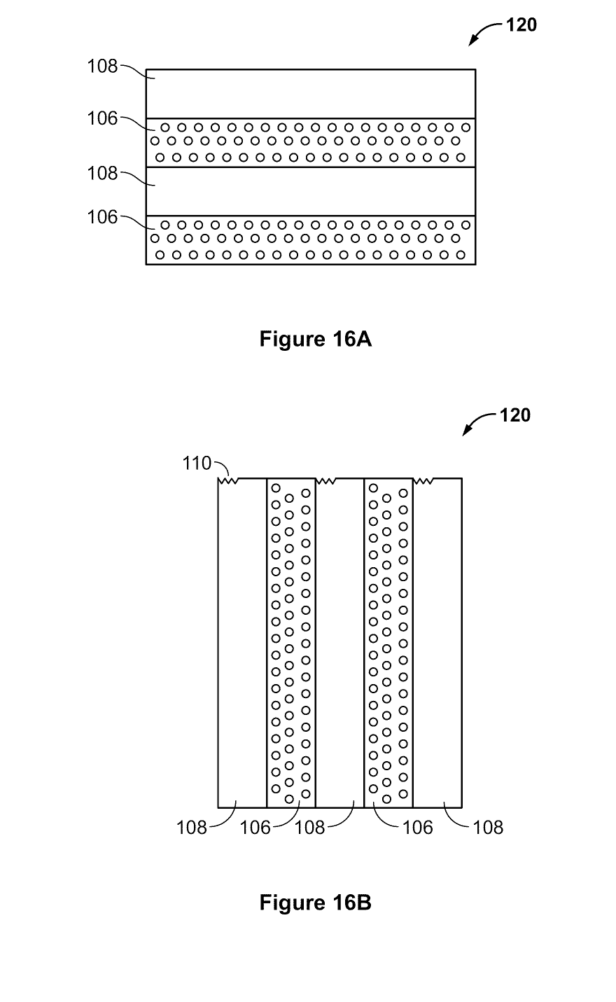

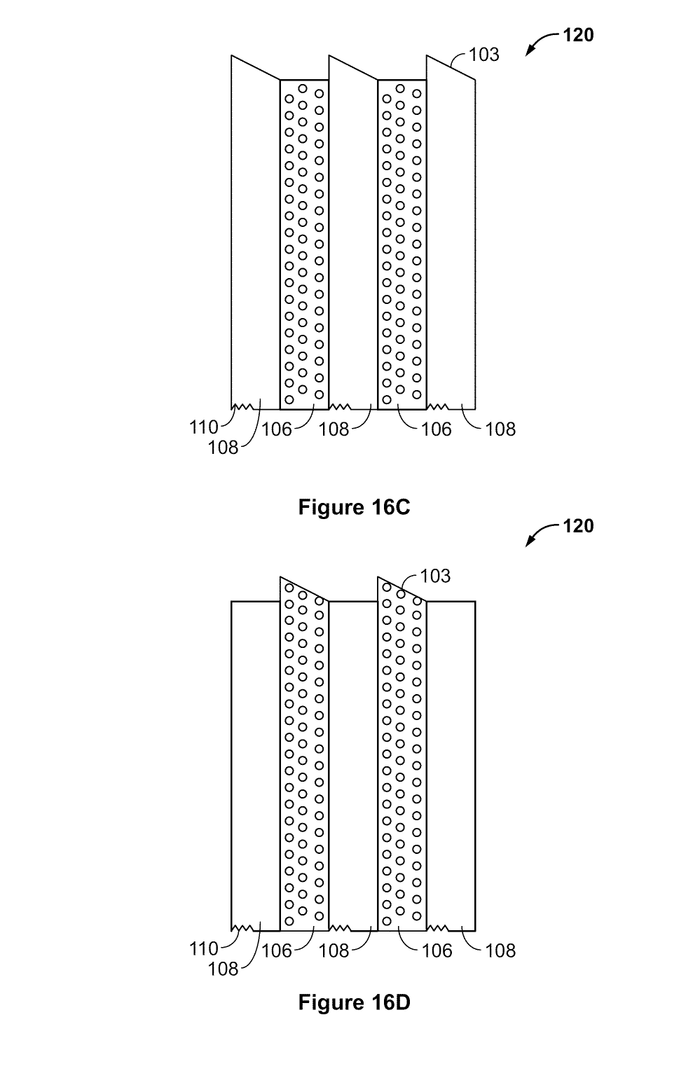

FIGS. 16A-16D illustrate an example of a method of making a manufactured substrate/diffuser 120 according to some implementations. The method may include forming alternating layers of substrate material (e.g., a glass material corresponding to substrate material areas 108) and layers having a volume diffuser (e.g., corresponding to volume diffusing areas 106). For example, an adhesive layer including diffusing particles may be deposited on a first layer of substrate material and a second layer of substrate material may be placed on the adhesive layer, thereby coupling the two layers of substrate material. This process may be repeated until the substrate/diffuser 120 has a thickness corresponding to a desired width of a display 30. The thicknesses of the substrate material areas 108 and/or the volume diffusing areas may correspond to the widths of active areas 34 and/or inactive areas 32 of a display 30. The substrate/diffuser 120 may then be rotated by 90 degrees for further processing.

The substrate/diffuser 120 may be cut into thickness T, for example to form a plurality of substrate/diffusers 120 for a plurality of displays 30 and/or for various portions of one display 30. A topographical pattern 110 may then be formed on a surface of the substrate material areas 108. The substrate/diffuser 120 may then be flipped 180° such that the surface of the substrate material areas 108 having the topographical pattern 110 is on a bottom surface, as illustrated in FIGS. 16C and 16D. The steering features 103 may then be formed on a top surface of the substrate/diffuser 120 (e.g., by a laser cutting process, or the like). The steering features 103 may be formed as part of the substrate material areas 108 as illustrated in FIG. 16C, or as part of the volume diffusing areas 106 as illustrated in FIG. 16D, or a combination thereof. The substrate/diffuser 120 may be cut at an angle to provide a slanted edge, for example having effects similar to the slanted wedge 6 described herein, and steering features 103 may be formed on the slanged edge.

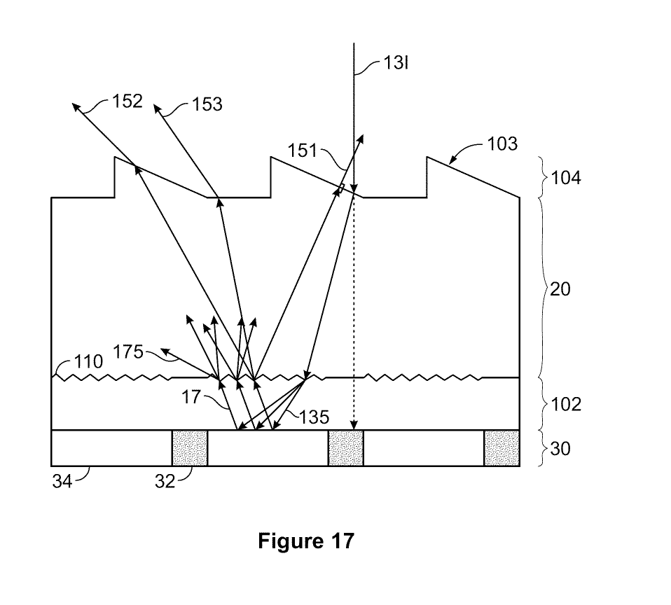

Diffusers can be applied to a display 30 as a plastic film that is laminated on the substrate 20 or formed on a surface of the substrate 20. FIG. 17 illustrates a diffuser 102 between a display 30 and a substrate 20 according to some implementations. In the example illustrated in FIG. 17, the diffuser 102 may include a topographical pattern 110 above at least a portion of the active regions 34 (or the entire area corresponding to the active region 34 as illustrated in FIG. 17). In some implementations, the diffuser 102 may include planar portions above at least a portion of the inactive regions 32 (or the entire area corresponding to the inactive regions 32 as illustrated in FIG. 17). Light 13I that would continue towards an inactive region 32 of the display 30 in the absence of a steering layer 104 (e.g., as illustrated by the dotted arrow in FIG. 17) is steered by the steering features 103 towards the active regions 34 (e.g., as illustrated by the solid line incident on the surface of the diffuser 102 in FIG. 17). The light is then scattered at the interface between the diffuser 102 and the substrate 20 by the topographical pattern 110, and scattered light 135 propagates towards the active regions 34. The scattered light is then reflected by the active regions 34 as illustrated by scattered reflected light 17 in FIG. 17. The scattered reflected light 17 is then further scattered on the return path by the topographical pattern 110, as illustrated by further scattered reflected light 175 in FIG. 17. The further scattered reflected light 175 is incident on different portions of the surface of the steering layer 104.

Light 151 is incident on a surface of a steering feature 103 at an angle of incidence equal to 90 degrees and is not redirected by the steering feature 103. Light 152 is incident on the steering feature 103 and is redirected by the steering feature 103 at an angle since the light 152 is not normal to the steering feature 103. Light 153 is incident on a flat surface of the steering layer 104 and is redirected at an angle since the light 153 is not normal to the flat surface. Light normally incident on a flat surface of the steering layer 104 is not redirected by the steering layer 104. As a result, light is received by a viewer at a plurality of angles including angles from the normal, thereby improving the performance of the display 30 at different display viewing angles.

The diffuser 102 of FIG. 17 is illustrated as including a topographical pattern 110. The diffuser 102 may be configured as a layer including a volume diffuser, including, for example, solid particles and a binding material. The binding material may be a spray on glass (SOG) material which forms a glass layer in a hardened state. In some implementations, the binding material may be plastic, polycarbonate, or the like. The solid particles may have a different refractive index than the binding material. In certain such implementations, the diffuser may include adhesive material that binds the substrate 20 and/or a substrate/diffuser 120 to the display 30.

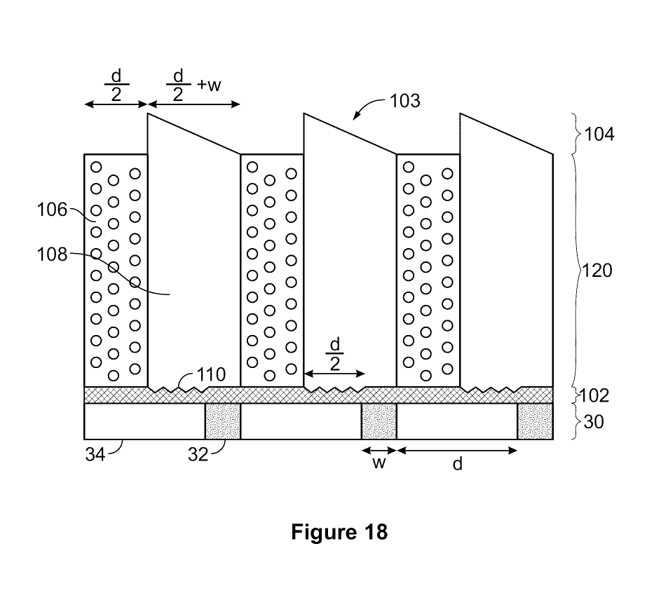

FIG. 18 illustrates an optical structure 100 including a substrate/diffuser 120 including a separate diffuser 102 according to some implementations. For example, with reference to FIG. 18, a diffuser 102 may be provided between the surface of the display 30 and the substrate/diffuser 120. The substrate/diffuser 120 may be similar to the substrate/diffuser 120 described above with reference to FIG. 15.

The diffuser 102 may include a topographical pattern 110 as illustrated in FIG. 18, or may include a volume diffuser (e.g., similar to the volume diffusing areas 106 of the substrate/diffuser 120). As discussed above with reference to FIG. 15, a steering feature 103 formed as half-prismatic arrays or other shapes described herein includes a first portion that covers an inactive region 32 and a second portion that partially covers an active region 34. The width of the steering features 103 is equal to d/x+w, where d is the width of an active region 34 and w is the width of an inactive region 32. When x=2, the steering features illustrated in FIG. 18 have a width equal to d/2+w, and the second portions cover half of the active regions 34. When the steering features 103 are a half prismatic array, the topographical pattern 110 (or a volume diffuser portion of the diffuser 102) may have the same widths as the second portion of the active regions 34 (e.g., d/2 as illustrated in FIG. 18) covered by the steering features 103.

The diffuser 102 may include a planarization layer (not shown) over the diffuser 102 (including the topographical patterns 110) that provides a planar surface at an interface between the diffuser 102 and the substrate/diffuser 120, or may be formed as part of a surface of the substrate/diffuser 120 as discussed above with reference to FIGS. 15 and 16A-16D.

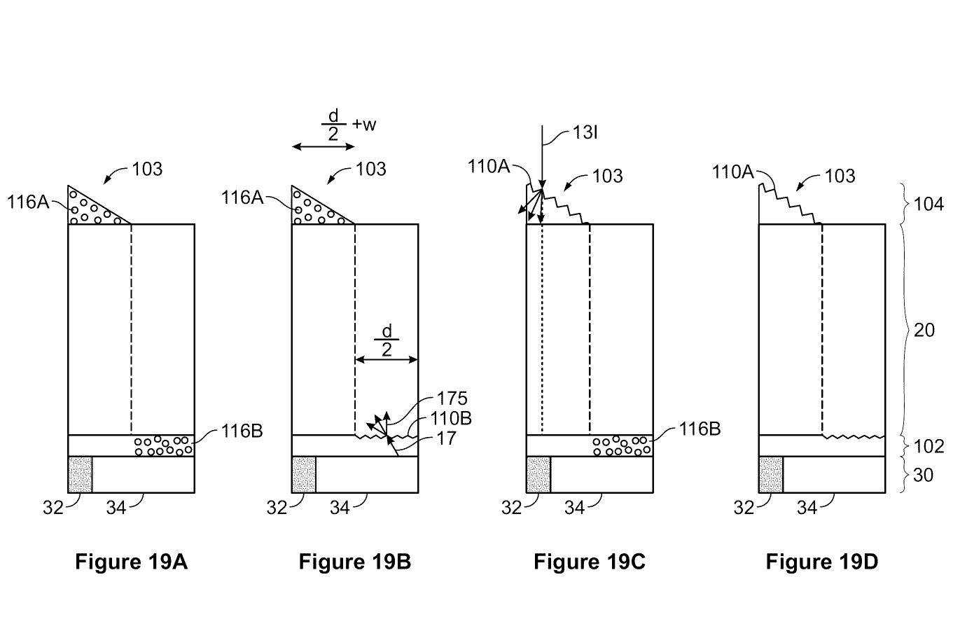

A diffusing element may also or alternatively be provided on a top surface of the steering features 103 and/or integrated with the steering features 103. FIGS. 19A-19D illustrate example variations of a display 30 including combinations of steering features 103, volume diffusers 116A, 116B, and topographical patterns 110A, 110B. The steering features 103 of FIGS. 19A-19D are illustrated as a half-prismatic array similar to that described herein with reference to FIGS. 15, 17, and 18, but are not limited thereto and may be similar to other steering features 103 described herein. As illustrated in FIG. 19A, the optical stack 100 may include steering features 103 including a volume diffusing layer 116A on top of a substrate 20 in combination with a volume diffusing portion 116B of a diffuser 102 as a first example. The optical structure 100 may also include steering features including a volume diffusing layer 116A in combination with a diffuser 102 having a topographical pattern 110B at an interface of the diffuser 102 and the substrate 20, as illustrated in FIG. 19B. The optical structure 100 may include steering features 103 having topographical patterns 110A on a surface of the steering features 3 in combination with a volume diffusing portion 116B of a diffuser 102, as illustrated in FIG. 19C. The optical structure 100 may include steering features 103 having a topographical pattern 110A in combination with a topographical pattern 110B at an interface of the diffuser 102 and the substrate 20, as illustrated in FIG. 19D. As described herein, light 13I that would be incident on an inactive region 32 in the absence of a steering layer 104 (e.g., as illustrated by the dotted line in FIG. 19C) may be scattered by the steering features 103 and be directed towards the active regions 34 and away from the inactive regions 32. Light 13 that is incident on the display 30 may be scattered by one or more of the diffusive features 116A, 116B, 110A, and 110B. Light 17 reflected from the display 30 may be scattered by one or more of the diffusive features 116A, 116B, 110A, and 110B (e.g., as illustrated by scattered light 175 in FIG. 19B).

The topographical pattern 110B may be formed as part of the bottom surface of the substrate 20, or may be provided as a separate layer between the substrate 20 and the display 30. The diffuser 102 and/or the substrate 20 may also include the volume diffusing portion 116B.

Light incident on the display 30 illustrated in FIGS. 19A-19D is diffused at multiple interfaces. As a result, by arranging diffusive elements above portions of the active regions 34 and inactive regions 32 as illustrated in FIGS. 19A-19D, the output profile of the reflected light as a function of the incident light angle can be enhanced.

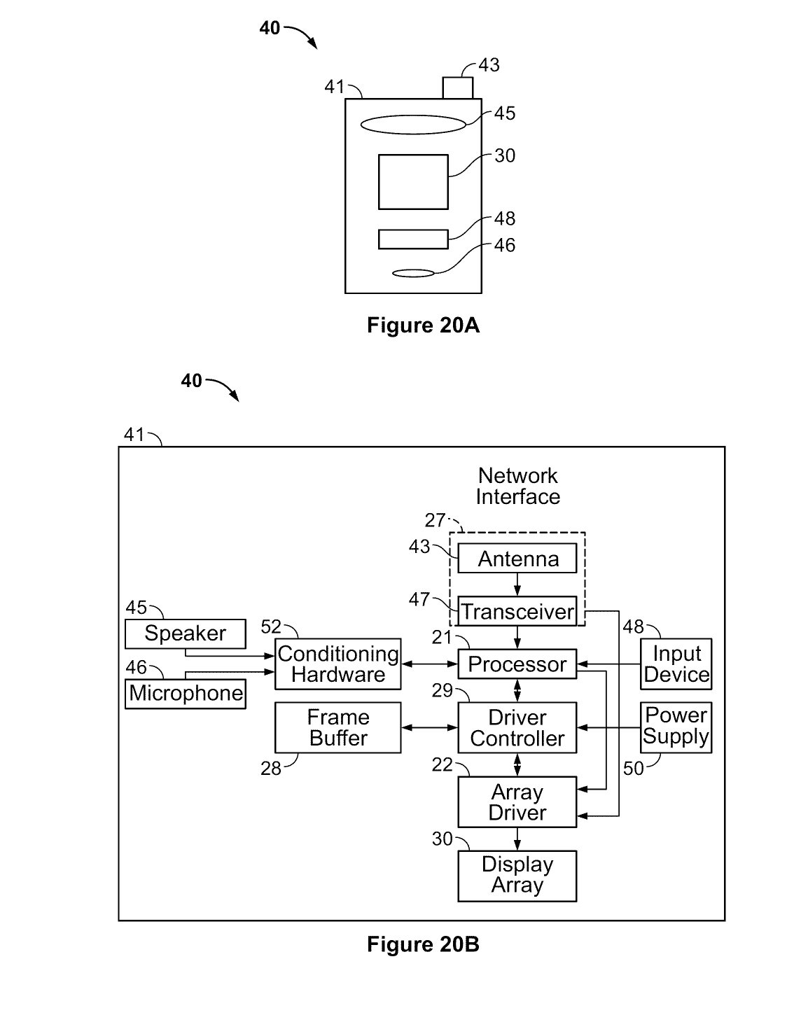

FIGS. 20A and 20B show examples of system block diagrams illustrating a display device 40 that includes a plurality of interferometric modulators. The display device 40 can be, for example, a cellular or mobile telephone. However, the same components of the display device 40 or slight variations thereof are also illustrative of various types of display devices such as televisions, e-readers and portable media players.

The display device 40 includes a housing 41, a display 30, an antenna 43, a speaker 45, an input device 48, and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber, and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an interferometric modulator display, as described herein.

The components of the display device 40 are schematically illustrated in FIG. 20B. The display device 40 includes a housing 41 and can include additional components at least partially enclosed therein. For example, the display device 40 includes a network interface 27 that includes an antenna 43 which is coupled to a transceiver 47. The transceiver 47 is connected to a processor 21, which is connected to conditioning hardware 52. The conditioning hardware 52 may be configured to condition a signal (e.g., filter a signal). The conditioning hardware 52 is connected to a speaker 45 and a microphone 46. The processor 21 is also connected to an input device 48 and a driver controller 29. The driver controller 29 is coupled to a frame buffer 28, and to an array driver 22, which in turn is coupled to a display array 30. A power supply 50 can provide power to all components as required by the particular display device 40 design.

The network interface 27 includes the antenna 43 and the transceiver 47 so that the display device 40 can communicate with one or more devices over a network. The network interface 27 also may have some processing capabilities to relieve, e.g., data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g or n. In some other implementations, the antenna 43 transmits and receives RF signals according to the BLUETOOTH standard. In the case of a cellular telephone, the antenna 43 is designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), NEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G or 4G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that is readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation, and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of pixels.

In some implementations, the driver controller 29, the array driver 22, and the display array 30 are appropriate for any of the types of displays described herein. For example, the driver controller 29 can be a conventional display controller or a bi-stable display controller (e.g., an IMOD controller). Additionally, the array driver 22 can be a conventional driver or a bi-stable display driver (e.g., an IMOD display driver). Moreover, the display array 30 can be a conventional display array or a bi-stable display array (e.g., a display including an array of IMODs). In some implementations, the driver controller 29 can be integrated with the array driver 22. Such an implementation is common in highly integrated systems such as cellular phones, watches and other small-area displays.

In some implementations, the input device 48 can be configured to allow, e.g., a user to control the operation of the display device 40. The input device 48 can include a keypad, such as a QWERTY keyboard or a telephone keypad, a button, a switch, a rocker, a touch-sensitive screen, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices as are well known in the art. For example, the power supply 50 can be a rechargeable battery, such as a nickel-cadmium battery or a lithium-ion battery. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, e.g., one or more modules of computer program instructions, encoded on a computer storage media for execution by, or to control the operation of, data processing apparatus.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. The word “exemplary” is used exclusively herein to mean “serving as an example, instance, or illustration.” Any implementation described herein as “exemplary” is not necessarily to be construed as preferred or advantageous over other implementations. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of the IMOD as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A display device comprising:
a light-modulating array including a plurality of light-modulating elements, the plurality of light-modulating elements including movable reflective surfaces and static reflective surfaces defining active regions of the light-modulating array spaced apart by inactive regions of the light-modulating array;
a steering layer including steering features configured to direct light away from the inactive regions and towards the active regions;
a substrate between the light-modulating array and the steering layer; and
a diffuser.

2. The display device of claim 1, wherein the diffuser is configured to interact with at least one of light propagating towards the active regions and light propagating away from the active regions.

3. The display device of claim 1, wherein the steering features include at least one of:
a one-dimensional prismatic array,
a two-dimensional prismatic array,
a lens array,
a residual prism array,
a residual lenslet array,
a partial reverse prismatic array,
a partial negative lenslet array,
a residual uni-directional array,
a half prismatic array,
a reverse trapezoidal array, and
a reverse prismatic array.

4. The display device of claim 1, wherein the steering layer includes the steering features on a slanted surface.

5. The display device of claim 1, wherein the diffuser is adjacent to the light-modulating array.

6. The display device of claim 1, wherein the substrate includes a volume diffuser configured to scatter light propagating through the substrate and incident on the light-modulating array.

7. The display device of claim 1, wherein the steering features include the diffuser.

8. The display device of claim 1, wherein the diffuser is on outer surfaces of the steering features.

9. The display device of claim 1, wherein the diffuser includes:
a first diffuser on outer surfaces of the steering features; and
a second diffuser adjacent to the light-modulating array.

10. The display device of claim 1, further comprising:
a planarization layer adjacent to the steering layer.

11. The display device of claim 10, wherein the planarization layer has a first refractive index and the steering layer has a second refractive index different than the first refractive index.

12. The display device of claim 1, further comprising:
a processor that is configured to communicate with the light-modulating array, the processor being configured to process image data; and
a memory device that is configured to communicate with the processor.

13. The display device of claim 12, further comprising:
a driver circuit configured to send at least one signal to the light-modulating array.

14. The display device of claim 13, further comprising:
a controller configured to send at least a portion of the image data to the driver circuit.

15. The display device of claim 12, further comprising:
an image source module configured to send the image data to the processor.

16. The display device of claim 15, wherein the image source module includes at least one of a receiver, a transceiver, and a transmitter.

17. The display device of claim 12, further comprising:
an input device configured to receive input data and to communicate the input data to the processor.

18. A method of manufacturing a display device, the method comprising:
forming a steering layer over a first side of a substrate, the steering layer including steering features configured to direct light towards active regions of a light-modulating array formed over a second side of the substrate opposite the first side and away from inactive regions of the light-modulating array, the light-modulating array including a plurality of light-modulating elements including movable reflective surfaces and static reflective surfaces defining the active regions of the light-modulating array spaced apart by the inactive regions of the light-modulating array, wherein the device includes a diffuser.

19. The method of claim 18, further comprising:
forming the diffuser as part of the steering layer.

20. The method of claim 18, further comprising:
forming the diffuser between the substrate and the light-modulating array.

21. The method of claim 18, further comprising:
forming the diffuser on outer surfaces of the steering features.

22. The method of claim 18, further comprising forming the diffuser, wherein forming the diffuser includes:
forming a first diffuser on outer surfaces of the steering features; and
forming a second diffuser adjacent to the light-modulating array.

23. The method of claim 18, further comprising forming the substrate, wherein forming the substrate includes:
forming a first layer including a first material;
forming a second layer including the first material; and
forming the diffuser between the first layer and the second layer.

24. The method of claim 23, wherein the first layer, the diffuser, and the second layer are generally parallel along a first direction, and wherein forming the steering layer includes removing a portion of at least one of the first layer, the diffuser, and the second layer from a surface that is substantially perpendicular to the first direction.

25. A display device comprising:
a light-modulating array including a plurality of light-modulating elements, the plurality of light-modulating elements including movable reflective surfaces and static reflective surfaces defining active regions of the light-modulating array spaced apart by inactive regions of the light-modulating array;
means for directing light away from the inactive regions and towards the active regions;
a substrate between the light-modulating array and the means for directing light; and
means for scattering light.

26. The display device of claim 25, wherein the means for directing light includes a steering layer including steering features, or wherein the means for scattering light includes a diffuser.

27. The display device of claim 25, wherein the means for scattering light is configured to interact with at least one of light propagating towards the active regions and light propagating away from the active regions.

28. The display device of claim 25, wherein the means for directing light includes at least one of:
a one-dimensional prismatic array,
a two-dimensional prismatic array,
a lens array,
a residual prism array,
a residual lenslet array,
a partial reverse prismatic array,
a partial negative lenslet array,
a residual uni-directional array,
a half prismatic array,
a reverse trapezoidal array, and
a reverse prismatic array.

29. The display device of claim 25, wherein the means for scattering light is adjacent to the light-modulating array.

30. The display device of claim 25, wherein the means for directing light includes the means for scattering light.

31. The display device of claim 25, wherein the means for scattering light is on outer surfaces of the means for directing light.

32. A display device comprising:
a display including active regions and inactive regions between the active regions;
a steering layer including steering features configured to direct light away from the inactive regions and towards the active regions, the steering features including:
first portions covering the inactive regions;
second portions partially covering the active regions; and
a substrate between the display and the steering layer.

33. The display device of claim 32, wherein the steering features include half-prismatic steering features or reverse prismatic steering features.

34. The display device of claim 32, wherein a width of one said second portion is about one half of a width of one said active regions.

35. The display device of claim 32, wherein the steering layer includes planar portions partially covering the active regions.

36. The display device of claim 35, wherein the second portions include a material and the planar portions include the material.
